(19) United States
(12) Patent Application Publication
(10) Pub. No.: US 2023/0260273 A1
(43) Pub. Date: Aug. 17, 2023

(54) SYSTEMS AND METHODS FOR ASSESSMENT OF PRODUCE SHELF LIFE USING TIME LAPSE IMAGE DATA

(71) Applicant: Apeel Technology, Inc., Goleta, GA (US)

(72) Inventors: Ohad MICHEL, Goleta, CA (US); Richard Pattison, Goleta, CA (US)

(21) Appl. No.: 18/168,101

(22) Filed: Feb. 13, 2023

Related U.S. Application Data
(60) Provisional application No. 63/309,876, filed on Feb. 14, 2022.

(51) Int. Cl. G06V 10/98; G06V 10/75; G06V 10/771; G06V 10/77; G06V 20/68; G06T 7/90

(52) U.S. Cl. CPC G06V 10/993; G06V 10/751; G06V 10/771; G06V 10/7715; G06V 20/68; G06T 7/90

(57) ABSTRACT

Systems and techniques for determining duration of produce using image data. A method can include receiving, by a computing system and from an imaging device, image data of produce that is captured at consistent time intervals during a period of time, the image data including one or more treated produce that is coated in a shelf life extension coating solution and one or more untreated produce that is not coated in the shelf life extension coating solution, performing object detection on the image data to identify a bounding box around each produce in the image data, identifying quality attributes in each bounding box at each of the time intervals during the period of time, and determining, for each produce, one or more duration scoring metrics based on comparing the identified quality attributes over the period of time.

### CROSS-REFERENCE TO RELATED APPLICATION

This application claims priority to U.S. Application No. 63/309,876, filed on Feb. 14, 2022, the disclosure of which is incorporated by reference in its entirety.

### TECHNICAL FIELD

This document generally describes devices, systems, and methods related to determining shelf life of food items, such as produce, using time lapse image data.

### BACKGROUND

Food items, such as produce, fruits, and meats can have different shelf lives that can impact their suitability for consumption and value in a supply chain. Multiple different stakeholders throughout the supply chain have an interest in evaluating produce shelf life. Shelf life can impact how long the produce can be on display for purchase by consumers before the produce is no longer salable or desired to be purchased by consumers. Sometimes, produce may move through the supply chain without being coated in a shelf life extension coating solution. As a result, the produce may reach the consumers with a shortened shelf life and/or characteristics that make the produce less desirable for purchase by the consumers. As a result, the produce may not be purchased and/or may become waste. Sometimes, produce may be coated in some type of shelf life extension coating solution, but may not be coated in the right quantity and/or type of solution. As a result, the produce may still reach the consumers with a shortened shelf life and/or characteristics that make the produce less desirable for purchase.

Objectively and quantitatively defining shelf life of produce based on image data can be challenging. Relevant stakeholders in the supply chain can observe and compare colors or other features that are visible in or on the produce. However, the human eye may only be able to distinguish color differences or other feature differences in extreme cases, such as when the differences are noticeably apparent. For example, the human eye may be able to distinguish when a lime is yellow, green, or brown, but the human eye may not be able to identify more subtle changes in color, which can be indicators of shelf life of the produce. Sometimes, the human eye may identify changes in color, but may not accurately quantify such changes. Subtle changes in color and other features can be representative of changes in quality of the food item, which impacts the produce's shelf life and salability.

### SUMMARY

This document generally describes systems, methods, and techniques for assessing shelf life of produce using image data. More particularly, the shelf life of produce can be determined from time lapse image data, such as a time lapse of hyperspectral images (HSIs), which can be generated and captured by one or more imaging devices, such as cameras that are configured to capture images of the produce within the visible light spectrum and/or outside of the visible light spectrum. In some implementations, hyperspectral image data can be captured by hyperspectral cameras at constant time differences and over some period of time. This image data can then be used to assess the shelf life of the produce. The image data can include images, as well as other image-related data and/or metadata, including but not limited to histograms, RGB color models, hyperspectral data, multispectral data, and/or video.

To assess shelf life of the produce, pixels representing produce in the time lapse image data can be extracted at one or more predetermined timeframes. Machine learning models and/or algorithms can then be applied to the extracted pixels to compute quality changes of the produce over time. Such quality changes can include color, volume, rot, firmness, wrinkles, mold, deterioration, infection, bruising, dry matter, pH, brix, sugar content, and/or desiccation. Accordingly, machine learning techniques can be used to identify and compute both internal and external quality attributes of the produce in combination to quantify shelf life, edibility, and/or salability of the produce. A shelf life of the produce can then be determined based on assessment of the identified quality changes.

The determined shelf life can be used by relevant stakeholders in a supply chain to identify how the produce ripens, a length of the produce's shelf life and/or salability, and how shelf life extension coating solutions may impact ripening, shelf life, and/or salability of the produce. For example, the disclosed techniques can also be used to determine a shelf life extension factor for produce that may be coated in a shelf life extension coating solution (e.g., treated produce) versus produce that may not be coated in the solution (e.g., untreated produce). In some implementations, a shelf life extension factor can be determined for a given environmental condition, which can be an average of shelf life ratio of treated and untreated produce over a statistically representative set of the produce.

The determined shelf life extension factor can be used by relevant stakeholders throughout the supply chain to make modifications to the shelf life coating solution, application of the solution to the produce, and/or quantities of the solution to apply to the produce. By using the disclosed techniques as described throughout this disclosure, treated produce can have increased and/or improved ripening, shelf life, edibility, and/or salability, thereby benefiting stakeholders in the supply chain and consumers. The shelf life extension factor can also be used to compare different coating solutions and their efficacy in extending the shelf life of the produce. The shelf life extension factor can also be used to compare treated and untreated produce in cold storage, retail, ambient environmental conditions, and other environmental conditions.

Particular embodiments described herein can include a method for determining duration of produce using image data, the method including: receiving, by a computing system and from an imaging device, image data of produce that can be captured at consistent time intervals during a period of time, the image data including one or more treated produce that can be coated in a shelf life extension coating solution and one or more untreated produce that may not be coated in the shelf life extension coating solution during the period of time, the treated produce and the untreated produce being a same produce type, performing, by the computing system, object detection on the image data to identify a bounding box around each of the produce in the image data, identifying, by the computing system, quality attributes in each bounding box at each of the time intervals during the period of time, determining, by the computing system and for each produce in the image data, one or more duration scoring metrics based on comparing the identified quality attributes over the period of time, and transmitting, by the computing system, the one or more duration scoring metrics for each of the produce to a user device for display in a graphical user interface (GUI).

In some implementations, the embodiments described herein can include one or more of the following features. For example, the method can include storing, by the computing system in a data store, (i) the bounding box around each produce in the image data, (ii) the quality attributes for each produce, and (iii) the duration scoring metrics for each produce. The method can also include determining, by the computing system, a grid structure for the image data, and assigning, by the computing system, a grid index in the grid structure to each bounding box, the grid index being used to identify the produce in the bounding box.

As another example, the method can include determining, by the computing system, a duration score for the produce in the image data based on determining an extension of shelf life duration from the one or more duration scoring metrics, the extension of shelf life duration being experienced by the treated produce in comparison to the untreated produce over the period of time. Moreover, the method can include determining, by the computing system and based at least in part on the one or more duration scoring metrics and the duration score for the produce, one or more modifications to make to the shelf life extension coating solution. The method can include transmitting, by the computing system, instructions to a controller of supply chain actors to modify the shelf life extension coating solution based on the determined one or more modifications. The one or more modifications can include instructions that, when executed by supply chain actors, cause at least one of (i) increasing a concentration of one or more components of the shelf life extension coating solution, (ii) decreasing a concentration of one or more components of the shelf life extension coating solution, (iii) applying the shelf life extension coating solution to a batch of untreated produce of the same produce type, (iv) increasing an amount of the shelf life extension coating solution to apply to subsequent batches of untreated produce of the same produce type, and (v) decreasing an amount of the shelf life extension coating solution to apply to subsequent batches of untreated produce of the same produce type.

In some implementations, the quality attributes can include at least one of color, volume, firmness, wrinkles, rot, and mold. The method can also include mapping, by the computing system, RGB values from the image data into three dimensional (3D) space, identifying, by the computing system, clusters of RGB values in the 3D space, selecting, by the computing system, one or more of the clusters in the 3D space having a threshold center color, and extracting, by the computing system, the selected one or more clusters from the image data, the selected one or more clusters being representative of the treated produce and the untreated produce in the image data.

In some implementations, identifying, by the computing system, quality attributes in each bounding box can include identifying color values for all pixels in the bounding box, and determining, by the computing system and for each produce in the image data, one or more duration scoring metrics can include: determining a distance between each of the identified color values and a statistical measure color value of the produce in the image data, determining whether a distance between each of the identified color values at each of the time intervals and the statistical measure color value exceeds a threshold level, identifying a duration scoring metric for each produce as a time interval during the period of time when the distance between each of the identified color values and the statistical measure color value exceeds the threshold level, and generating output that visually depicts the distance between each of the identified color values and the statistical measure color value for the produce at each time interval during the period of time. Moreover, the statistical measure color value can be determined, by the computing system, based on: receiving, from the imaging device, image data of the produce at a first time interval during the period of time, identifying color values for all pixels representing the produce in the image data at the first time interval, and computing the statistical measure color value for the produce in the image data based on averaging the identified color values. The statistical measure color value can represent an average color of the treated produce and the untreated produce when the produce is imaged by the imaging device at a first time interval during the period of time.

In some implementations, the one or more duration scoring metrics can correspond to, for each of the produce in the image data, at least one of ripeness, end of ripeness, length of ripeness, shelf life, end of shelf life, length of shelf life, edibility, end of edibility, length of edibility, salability, end of salability, and length of salability of the produce.

Sometimes, identifying, by the computing system, quality attributes in each bounding box can include: determining an area of the produce in the bounding box based on counting a number of pixels representing the produce in the bounding box, determining a radius of the produce based on the area and a circle area formula, and determining a volume of the produce at each time interval based on the radius and a spherical volume formula. Determining, by the computing system and for each produce in the image data, one or more duration scoring metrics further can include: determining a change in the volume of the produce at each time interval to a volume of the produce at a first time interval, determining whether the change in volume exceeds a threshold level, identifying a duration scoring metric for each produce as a time interval during the period of time when the change in volume exceeds the threshold level, and generating output that visually depicts the change in volume for each produce at each time interval during the period of time. In some implementations, the threshold level can be a 10% volume shrink between the volume of the produce at one of the time intervals and the volume of the produce at the first time interval.

In some implementations, identifying, by the computing system, quality attributes in each bounding box can include determining a grid structure for the produce in the bounding box, retrieving, from a data store, a wrinkle model that was trained using machine learning, and applying the wrinkle model to each grid cell in the grid structure to identify one or more patches of wrinkles. Determining, by the computing system and for each produce in the image data, one or more duration scoring metrics can include: counting a fraction of grid cells having the patches of wrinkles for the bounding box, determining whether the fraction of grid cells having the patches of wrinkles exceeds a threshold level, identifying a duration scoring metric for the produce as a percent coverage in wrinkles based on a determination that the fraction of grid cells having the patches of wrinkles exceeds the threshold level, and generating output that visually depicts the percent coverage in wrinkles for the produce. The wrinkle model was trained using a set of training image data of other produce of the same type, the set of training image data being annotated based on previous identifications of a first portion of the other produce as having wrinkles and a second portion of the other produce as having no wrinkles.

In some implementations, identifying, by the computing system, quality attributes in each bounding box can include: determining a grid structure for the for the produce in the bounding box, retrieving, from a data store, a quality features model that was trained using machine learning, and applying the quality features model to each grid cell in the grid structure to identify one or more quality features. Determining, by the computing system and for each produce in the image data, one or more duration scoring metrics can include: counting a fraction of grid cells having the quality features for the bounding box, determining whether the fraction of grid cells having the quality features exceeds a threshold level, identifying a duration scoring metric for the produce as a percent coverage in quality features based on a determination that the fraction of grid cells having the quality features exceeds the threshold level, and generating output that visually depicts the percent coverage in quality features for the produce. The quality features model was trained using a set of training image data of other produce of the same type, the set of training image data being annotated based on previous identifications of a first portion of the other produce as having one or more of the quality features and a second portion of the other produce as having no quality features. Moreover, the quality features can include at least one of firmness, internal bruising, external bruising, internal infection, external infection, internal rot, external rot, dry matter content, pH, and sugar content.

In some implementations, the produce in the image data can be avocados, (i) the quality attributes can be at least one of color, volume, firmness, and ripeness, and (ii) the one or more duration scoring metrics can be at least one of a change in color over the period of time, a change in volume over the period of time, a change in firmness over the period of time, and a change in ripeness over the period of time. The produce in the image data can be limes, the quality attributes can be at least one of color and volume, and the one or more duration scoring metrics can be at least one of a change in color and a change in volume over the period of time. The produce in the image data can be apples, (i) the quality attributes can be at least one of color and firmness, and (ii) the one or more duration scoring metrics can be at least one of a change in color over the period of time and a change in firmness over the period of time.

As another example, the method can also include identifying, by the computing system, produce type of the produce in the image data at a first time interval during the period of time, selecting, by the computing system, one or more types of duration scoring metrics from a plurality of duration scoring metrics for the identified produce type, selecting, by the computing system, one or more threshold levels for the selected types of duration scoring metrics for the identified produce type, identifying, by the computing system, the quality attributes that correspond to each of the selected types of duration scoring metrics, and determining, by the computing system, the selected one or more duration scoring metrics based on comparing the identified quality attributes with the selected one or more threshold levels.

In some implementations, the method can also include retrieving, by the computing system and from a data store, duration scoring metrics of the treated produce and the untreated produce over the period of time, identifying, by the computing system, one or more differences between the duration scoring metrics of the treated produce and the duration scoring metrics of the untreated produce, and generating, by the computing system, output indicating the identified one or more differences. The generated output can include one or more modifications to the shelf life extension coating solution, the one or more modifications being determined, by the computing system, based on the identified one or more differences.

As another example, the produce can be at least one of an avocado, a lime, a lemon, an apple, and a mango. The image data can include at least one of color data, RGB color models, hyperspectral image data, time lapse video data, and time lapse hyperspectral image data.

One or more embodiments described herein can include a system for determining duration of produce using image data, the system including a conveyor system that can be configured to route produce along a pathway through a facility, one or more imaging devices positioned proximate the conveyor system that can be configured to capture image data of the produce at consistent time intervals during a period of time, the produce being a same produce type, and at least one computing system in communication with the one or more imaging devices. The at least one computing system can be configured to: receive, from the one or more imaging devices, image data of the produce that is captured at the consistent time intervals during the period of time, the image data including one or more treated produce that can be coated in a shelf life extension coating solution and one or more untreated produce that may not be coated in the shelf life extension coating solution during the period of time, the treated produce and the untreated produce being of the same produce type, perform object detection on the image data to identify a bounding box around each produce in the image data, identify quality attributes in each bounding box at each of the time intervals during the period of time, determine, for each produce in the image data, one or more duration scoring metrics based on comparing the identified quality attributes over the period of time, and transmit the one or more duration scoring metrics for each of the produce to a user device for display in a graphical user interface (GUI).

In some implementations, the system can optionally include one or more of the abovementioned features.

The disclosed technology may provide one or more of the following advantages. For example, the disclosed techniques can be used to quantitatively assess effects of a shelf life extension coating solution on produce ripeness, shelf life, edibility, and/or salability. The disclosed techniques can therefore be used to improve the shelf life extension coating solution and/or application of the solution to produce. Produce coated in the improved solution may experience improved ripening, shelf life, edibility, and/or salability. Further down in the supply chain, consumers may be more inclined to purchase the produce, which can reduce produce-based waste and thus improve produce salability.

As another example, produce quality can be more accurately determined from subtle differences that appear in image data over time. The human eye may be prone to error in trying to observe subtle changes in the appearance of produce. Moreover, the human eye may not be able to quantify and correlate changes in appearance with quality attributes, such as ripeness, shelf life, edibility, and/or salability of the produce. The disclosed techniques can provide for automatically and accurately detecting different external and internal quality features in produce from image data that is captured over time (e.g., time lapse image data, such as time lapse HSIs). More particularly, HSI data can be used for the identification and quantification of internal quality changes that may otherwise not be readily visible to the human eye. The disclosed techniques therefore provide deeper analysis into quality of the produce while also reducing potential human error that may occur from visual observation and inspection of produce.

As another example, the disclosed techniques can be used to modify shelf life extension coating solutions to reduce produce-based waste and ensure that produce delivered to consumers is desirable for purchase and consumption. By analyzing ripeness and other quality changes over time for treated produce (e.g., produce that is coated in the solution) and untreated produce (e.g., produce that is not coated in the solution), analysis can be performed to determine improvements that can be made to the shelf life coating solution. Such improvements can be implemented and applied to produce before the produce is delivered to consumers in a retail environment. Improving the shelf life extension coating solution and/or application of the solution early in the supply chain can be advantageous to improve the ripeness, shelf life, edibility, and/or salability of the produce by the time the produce reaches consumers.

Similarly, shelf life extension factors determined using the disclosed techniques can be advantageous for retailers to identify return on investments (ROIs) for their produce. Such factors can be used by retailers and other relevant stakeholders to determine which produce to order (e.g., treated versus untreated), which produce to put out on the shelves for customers, how to arrange the produce on the shelves in a way that reduces produce-based waste (e.g., more ripe produce can be placed in front of less ripe produce), and/or how to price the produce (e.g., based on whether the produce is treated, the produce's ripeness, other quality features). Thus, the disclosed techniques can be used to monitor quality of produce and make modifications that improve or maintain the quality of the produce throughout the supply chain.

As described throughout, the disclosed techniques can also generate more robust quality assessments of produce. Different algorithms, techniques, and machine learning models can be used to identify and score various quality features associated with different types of produce. Thus, the disclosed techniques can be used to identify changes in quality features over time that otherwise may be difficult for humans to observe and associate with quality features of the produce.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram for determining shelf life of produce using time lapse image data.

FIG. 2A is a conceptual diagram for training one or more models to identify quality features of the produce using machine learning techniques.

FIG. 2B is a conceptual diagram for training one or more models to determine shelf life of the produce based on identified changes in quality features over time.

FIGS. 3A-B is a flowchart of a process for determining shelf life of produce.

FIG. 4 is a flowchart of a process for determining a color quality metric for produce.

FIG. 5 is a flowchart of a process for determining a statistical measure color value for produce.

FIG. 6 is a flowchart of a process for determining a volume quality metric for produce.

FIG. 7A is a flowchart of a process for determining a wrinkle quality metric for produce.

FIG. 7B depicts training and runtime application of a machine learning model that determines the wrinkle quality metric of produce in FIG. 7A.

FIG. 8 is a flowchart of a process for determining a quality features metric for produce.

FIG. 9 is an example system diagram of components used for determining shelf life of produce using the techniques described herein.

FIG. 10 is an example environment for capturing time lapse image data of produce.

FIG. 11 depicts example time lapse image data comparing treated and untreated produce.

FIG. 12 is an example shelf life analysis of avocados, using the disclosed techniques.

FIG. 13 is an example statistical measure color determination for avocados using the process of FIG. 5.

FIG. 14 is an example color analysis over time of avocados using the processes of FIGS. 3-5.

FIG. 15 is an example volume analysis over time of avocados using the process of FIG. 6.

FIG. 16 is an example shelf life analysis of avocados based on volume, using the disclosed techniques.

FIG. 17 is an example shelf life analysis of limes using the disclosed techniques.

FIG. 18 depicts example techniques for extracting apples or other produce from image data.

FIG. 19 is an example shelf life analysis of apples using the disclosed techniques.

FIG. 20 is a flowchart of a process for determining what quality metrics, machine learning models, and/or quality thresholds to select for a type of produce that is being imaged over time.

FIG. 21 is a flowchart of a process for comparing shelf life of treated versus untreated produce to determine one or more modifications to a shelf life extension coating solution.

FIG. 22 is a block diagram of system components that can be used to implement a system for assessing the quality of one or more food items.

### DETAILED DESCRIPTION

The present disclosure is directed towards systems, methods, and computer programs for assessing quality of produce from time lapse image data. The produce can be any type of produce, including but not limited to fruits and vegetables. The disclosed techniques can also be used to assess quality of other food items, such as meat and fish. The image data can be HSIs that are captured at constant, predetermined time points of the same batch of produce. The image data can also be other times of image data, including but not limited to videos. The disclosed technology can provide for obtaining image data of treated and untreated produce and determining, based on evaluation of quality features that are identified in the image data, ripeness, shelf life, edibility, and/or salability of the produce. Ripeness, shelf life, edibility, and/or salability of the produce can be identified as a duration score of the produce. The duration score can indicate how long the produce is or will be ripe, how long the produce may be edible until it reaches an end of its shelf life and/or salability, and other characteristics indicative of a duration that the produce may be desired, purchased, and/or consumed by consumers. The duration scores of treated produce can be compared to the duration scores of untreated produce in order to determine whether any modifications should be made to a shelf life extension coating solution that is applied to the treated produce. Such modifications can improve the coating solution and thereby improve ripeness, shelf life, edibility, and/or salability of produce that is treated with the coating solution.

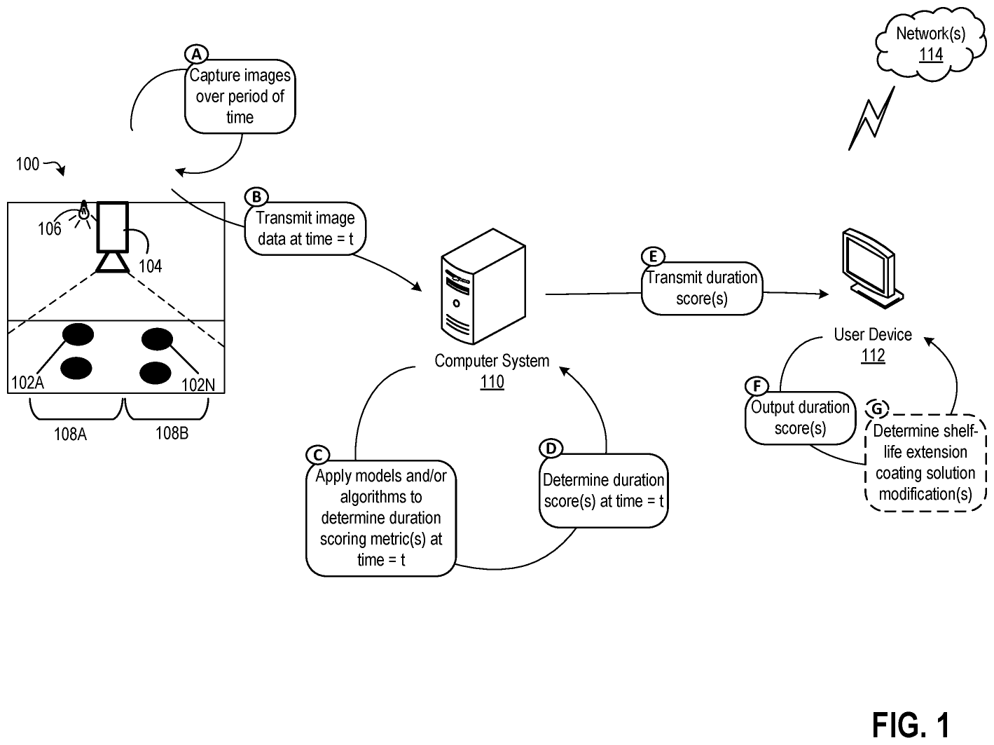

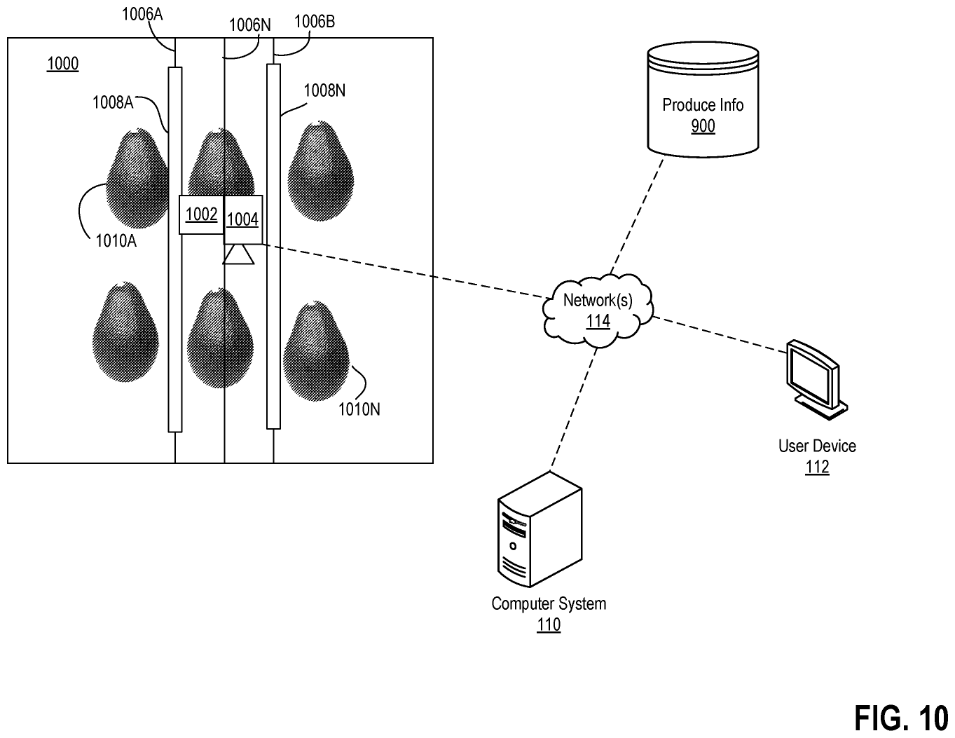

Referring to the figures, FIG. 1 is a conceptual diagram for determining shelf life of produce using time lapse image data. A computer system 110, imaging device 104, and user device 112 can be in communication (e.g., wired and/or wireless) via network(s) 114. The computer system 110 can be configured to assess quality of imaged produce in order to determine duration of that produce (e.g., shelf life, edibility, salability, ripeness), as described throughout this disclosure. The imaging device 104 can be placed in an imaging environment 100. The imaging environment 100 can be located in a storage facility or other environment along the supply chain. The imaging environment 100, as described further in reference to FIG. 10, can be an enclosure, such as a box, that can be moved around the storage facility (e.g., from room to room). In some implementations, the imaging environment 100 can be a room. Moreover, in some implementations, the computer system 110 can be an edge computing device that is deployed in the imaging environment 100. The computer system 110 can then perform processing of the image data quickly and efficiently, thereby reducing clogging of network bandwidth and use of computational resources.

The imaging environment 100 can include the imaging device 104 and at least one light source 106. Produce 102A-N can be placed inside the imaging environment 100 for a duration of time as the imaging device 104 captures images of that produce 102A-N. Treated 108A produce and untreated 108B produce can be placed inside the imaging environment 100. A sampling of a batch of treated 108A produce can be selected as well as a sampling of a batch of untreated 108B produce. The sampling of the treated 108A produce can therefore represent the entire batch of treated 108A produce and the sampling of the untreated 108B produce can represent the batch of untreated 108B produce. As a result, the computer system 110 can compare quality changes in both treated 108A and untreated 108B produce 102A-N to determine efficacy and potential modifications to a shelf life extension coating solution that coats the treated 108A produce.

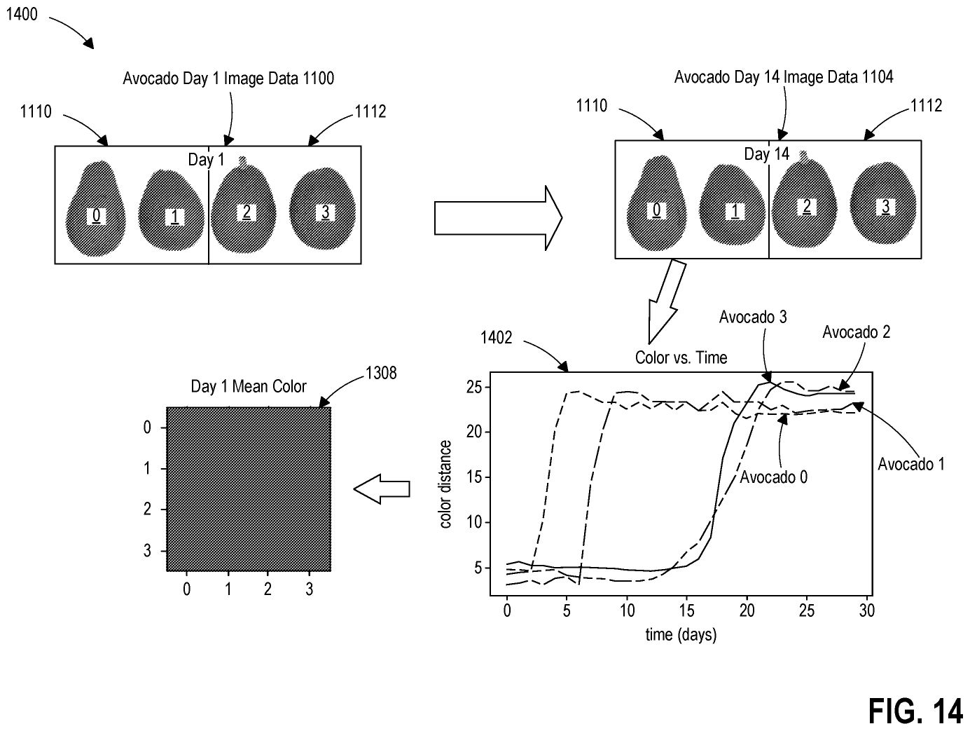

The imaging device 104 can be configured to capture image data of the produce 102A-N over a predetermined period of time (A). As described herein, the image data can be HSIs, thermal images, 2D images, and/or videos. The predetermined period of time can vary depending on the type of produce that is being imaged in the imaging environment 100. For example, avocados can be imaged over 30 days and apples can be imaged over 100 days. The amount of time that produce 102A-N is imaged can vary. The produce 102A-N can be imaged for an amount of time that is long enough to see a full range of change in at least one feature of that produce 102A-N. For example, avocados can be imaged until the avocados don't change in volume anymore (e.g., they are no longer shrinking). As another example, apples can be imaged until all the apples (e.g., both treated and untreated) are fully changed in color. The produce 102A-N can also be imaged at constant time differences and/or intervals during the predetermined period of time. For example, the produce 102A-N can be imaged every 12 hours, 24 hours, etc. during a 30 day period of time. The produce 102A-N can be imaged daily. Frequency of imaging can also be adjusted based on times of change for the feature(s) of interest in the produce 102A-N. For example, if an apple variety changes color consistently and/or smoothly over 60 days on average, a sampling rate can be reduced from a 1-day sampling rate. Instead, for example, the apples can be sampled (e.g., imaged) every 10 days. As another example, if avocados change color very quickly and over a few days (as shown in FIG. 14), a sampling rate of at least 1-day sampling rate can be used. In some implementations, the sampling rate for avocados can be every couple hours. Therefore, the produce 102A-N can be imaged at a rate that can be determined based on a duration of the feature(s) that is being captured by the images divided by a number of data points required to clearly see a signal indicative of the feature(s). In some implementations, the number of data points can be 10. One or more ranges can also be used, including but not limited to between 5-15 data points. One or more other ranges are also possible. As described herein, the produce 102A-N can be avocados, citrus fruits, apples, other types of fruits, and/or other food items that can be treated, untreated, stored in a storage facility, and/or transported through the supply chain to consumers.

The imaging device 104 can transmit the image data to the computer system 110 at time=t (B). The imaging device 104 can transmit the image data at predetermined time intervals over the period of time that the produce 102A-N is being imaged. For example, the imaging device 104 can transmit the image data in a batch every 24 hours, every 48 hours, etc. during a 30 day period of time. The imaging device 104 can also transmit the image data once it is captured, in real-time. For example, if the image data is captured at time=1, then the image data can be transmitted to the computer system 110 at time=1.

The computer system 110 can then apply one or more models and/or algorithms to the image data to determine duration scoring metric(s) of the produce 102A-N at time=t (e.g., the time when the produce 102A-N was imaged) (C). Duration scoring metrics can be quality features of the produce 102A-N that change over time and impact the produce 102A-N's ripeness, shelf life, edibility, and/or salability. Duration scores, which can be derived from the duration scoring metrics using the techniques described herein, can be any one or more of an age, ripeness, shelf life, salability, quality, duration of shelf life, duration of salability, and/or number of days until the produce 102A-N reaches the end of its shelf life or salability.

By applying the models and/or algorithms to the image data of the produce at each time point that the image data is captured, the computer system 110 can quantify quality changes of the treated 108A and untreated 108B produce 102A-N, and consequently, an impact of the quality changes on the produce 102A-N's duration (e.g., ripeness, shelf life, edibility, salability). The computer system 110 can also utilize the impact of the quality changes on the produce 102A-N's duration to determine an effect/efficacy of a shelf life extension coating solution on the treated 108A produce in comparison to the untreated 108B produce.

As described further herein, the computer system 110 can select one or more models and/or algorithms to apply in step C based on the type of produce 102A-N that is being imaged. In some implementations, the computer system 110 can analyze one quality feature for the produce 102A-N and therefore apply one model and/or algorithm. As an example, the computer system 110 can analyze a color metric for apples to determine quality changes and the duration score for the apples. The computer system 110 can therefore select and apply a particular model and/or algorithm for assessing the color metric for apples, or a particular type of apple. In some implementations, the computer system 110 can analyze more than one quality feature for the produce 102A-N and therefore may apply more than one model and/or algorithm. As an example, the computer system 110 can analyze a color metric and a volume metric for avocados to determine quality changes and the duration score for the avocados. The computer system 110 can therefore select and apply one or more models and/or algorithms for assessing both the color and volume metrics for avocados. The computer system 110 can also analyze one or more other quality features, including but not limited to external and internal attributes of produce, such as rot, desiccation, browning, wrinkling, and other quality features.

The computer system 110 can then determine duration score(s) for the produce 102A-N in the image data at time=t (D). The computer system 110 can determine a duration score for the treated 108A produce and a duration score for the untreated 108B produce. As described herein, the duration scores can be based on a quantitative assessment of the duration scoring metrics determined in step C.

The computer system 110 can transmit the duration score(s) to the user device 112 (E). The user device 112 can then output the duration score(s) (F). In some implementations, the duration score(s) can be outputted in the form of a histogram or other graphical depiction. The histogram, for example, can provide a comparison of the quality changes (e.g., the duration scoring metrics) for the treated 108A produce and the untreated 108B produce over the predetermined period of time. The duration scores determined in step D can be plotted at time=t for the predetermined period of time. The histogram can also include a threshold, which indicates when the particular type of produce 102A-N is expected to meet its end of duration (e.g., end of shelf life, salability, edibility, and/or ripeness). The threshold can be determined based on analysis of edible shelf life, marketing, and salability information about the particular type of produce 102A-N.

In some implementations, the duration score(s) can be outputted in step F in a variety of other ways, including but not limited to as a numeric value. For example, the duration score(s) can be outputted as a number of days remaining in shelf life for the treated 108A produce and the untreated 108B produce. The duration score(s) can also be outputted as a number of days of total shelf life for the treated 108A produce and the untreated 108B produce. In some implementations, the duration score(s) can also be outputted as a shelf life extension factor, which is a comparison of the shelf life of the treated 108A produce versus the untreated 108B produce. Therefore, the shelf life extension factor can indicate how much longer the shelf life of the treated 108A produce has been extended in comparison to the untreated 108B produce since the treated 108A produce is coated in the shelf life extension coating solution.

Optionally, shelf life extension coating solution modifications can be determined (G). Such modifications can be automatically determined by the computer system 110 and then transmitted to and outputted at the user device 112. In some implementations, the modifications can be determined by a relevant stakeholder at the user device 112. When such modifications are determined, the modifications can be automatically, semi-autonomously, and/or manually implemented. For example, the modification can include coating untreated produce in subsequent batches with the same quantity of shelf life extension coating solution as was put on the treated 108A produce that was imaged. Another modification can include adjusting a concentration of the shelf life extension coating solution or otherwise modifying one or more characteristics/composition of the solution. Another example modification can include applying a different quantity of the solution to subsequent batches of produce. Yet another example modification can include applying the solution at one or more different time periods during a ripening process of subsequent batches of produce. One or more other modifications can be determined and applied in order to improve the shelf life extension coating solution and/or improve the duration score of subsequent batches of produce (and thereby extending the produces' ripeness, shelf life, edibility, and/or salability).

The user device 112 can be a mobile device, smartphone, tablet, laptop, or other computer that can be used by a relevant stakeholder in the supply chain. The stakeholder can view the duration scoring metrics and duration scores for each of the treated 108A produce and the untreated 108B produce over the predetermined period of time. As a result, the stakeholder can more accurately assess efficacy of the shelf life extension coating solution that was applied to the treated 108A produce and determine potential modifications to make in the supply chain to improve the duration scores of subsequent batches of produce. Thus, the outputted metrics and/or scores can be used by the stakeholder to monitor quality changes of the produce 102A-N over time and optionally make one or more modifications in the supply chain.

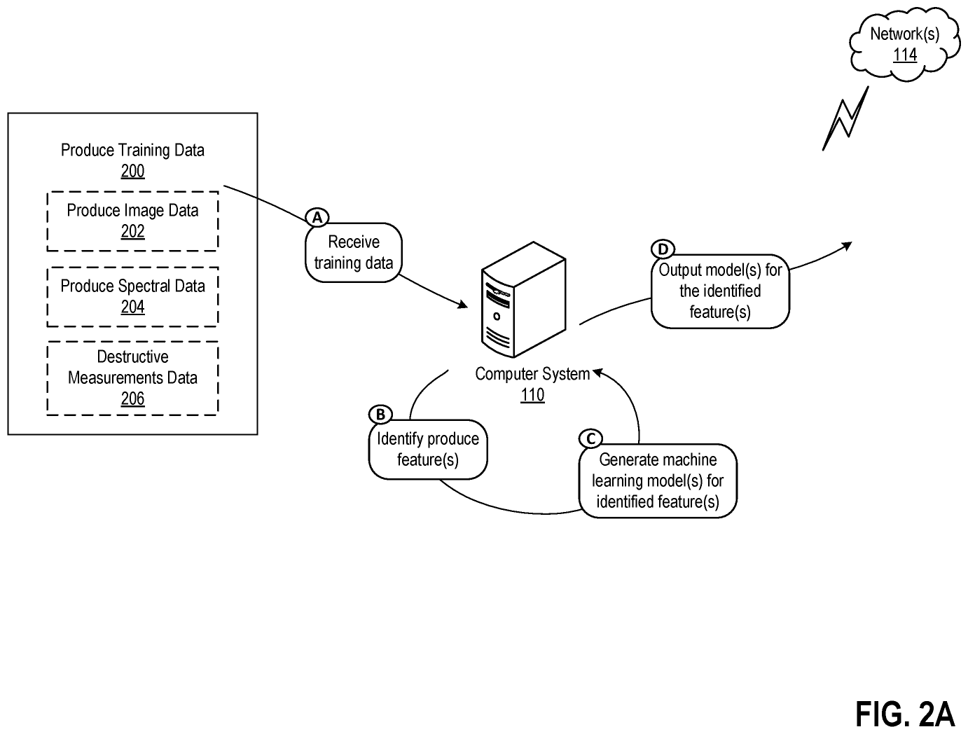

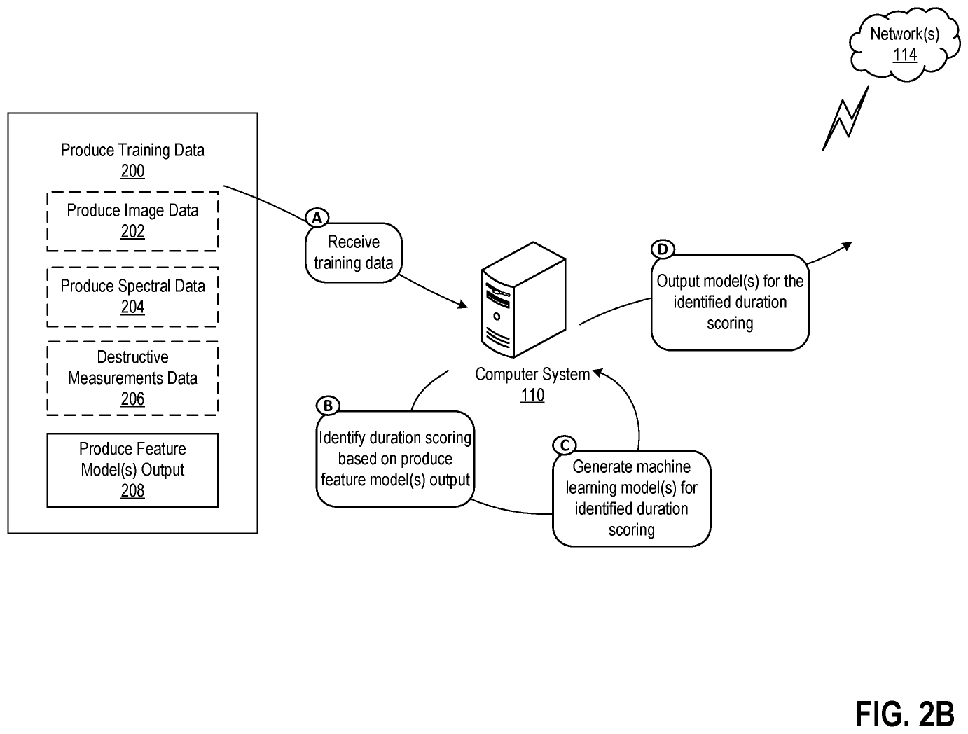

FIG. 2A is a conceptual diagram for training one or more models to identify quality features of the produce using machine learning techniques. Models can be generated for different produce, different types of produce, and different features associated with different produce. For example a model can be generated and trained to identify a color metric for avocados. Another model can be generated and trained to identify a color metric for apples, or a particular type of apples, such as Granny Smith apples. Yet another model can be generated and trained to identify a color metric for different types of produce, such as all citrus fruits. Yet another example model can be generated and trained to identify a color metric for any produce, regardless of type. One or more other models can be trained to identify other features of produce, including but not limited to volume, firmness, wrinkles, rot, desiccation, sugar content, Brix, and other internal and external features of the produce. In some implementations, one or more algorithms can be developed instead of or in addition to models that identify and quantify quality features that change over time for produce and therefore affect the produce's duration (e.g., shelf life, edibility, salability, and/or ripeness).

Training and model generation can be performed by the computer system 110. In some implementations, training and model generation can be performed by one or more other computing systems, devices, cloud-based services, and/or network of computers and/or devices.

The computer system 110 can receive produce training data 200 (A). The produce training data 200 can optionally include one or more types of data. For example, the produce training data 200 can include produce image data 202, produce spectral data 204, and/or destructive measurements data 206. Thus, the produce training data 200 can therefore include histograms, RGB color models, hyperspectral data, multispectral data, etc. depicting a particular produce, produce type, different produce, different produce types, a single produce, and/or a batch of produce. The produce training data 200 can include images of a particular produce having some particular feature to be modeled, such as color, and images of the same type of produce that does not have the particular feature to be modeled. The produce training data 200 can also include images of a particular produce that has been treated with shelf life extension coating solution and images of the same type of produce that has not been treated with the solution. In some implementations, the produce training data 200 can include images of an exterior of the produce and/or an interior of the produce. The produce training data 200 can also include images of a particular produce at different stages of ripeness and between stages of ripeness.

The produce training data 200 can be a robust collection of training data indicating a plurality of different features that may exist for one or more types of produce throughout the produce's lifecycle. Destructive measurements data 206 can include measurements that have been taken of different quality features of the produce. For example, produce firmness can be measured using a penetrometer and/or durometer. Measurements captured by the penetrometer and/or durometer can be correlated with the produce image data 202 and/or the produce spectral data 204 in order to quantify quality features and quality changes in the produce.

The produce training data 200 can be retrieved from one or more databases or data stores. The produce training data 200 can also be received from imaging devices, in some implementations.

The computer system 110 can identify features of the produce from the image data (B). The computer system 110 can identify features indicative of a quality of the produce. For example, the computer system 110 can identify a color of the produce, rot, mold, different types of texture, bruising, etc. The identified features can also be labeled. The computer system 110 can identify such features at one or more different time points throughout the produce's lifecycle and/or shelf life. For example, the produce training data 200 can include images of the produce at constant time intervals throughout the produce's lifecycle. The computer system 110 can then identify, at each of the time intervals, one or more features indicative of the quality of the produce.

The computer system 110 can then generate machine learning models for the identified features (C). The models can be generated using machine learning techniques, including but not limited to convolution neural networks (CNNs). One or more other machine learning techniques can be used to generate and train the models. The computer system 110 can generate a model for each of the identified and labeled features. Thus, each model can be trained to identify a particular feature from image data of the same type of produce during runtime use. In some implementations, the computer system 110 can generate a model to identify one or more features associated with a particular type of produce. Thus, each model can be trained to identify one or more features (e.g., color, volume, wrinkles, other quality features) from image data of a particular type of produce, such as avocados.

The generated models can then be outputted by the computer system 110 (D). Outputting the models can include storing the models in a database, data store, and/or cloud storage. Outputting the models can also include maintaining the models in local memory and/or storage such that they can be easily and quickly retrieved and applied during runtime. Accordingly, during runtime, one or more of the models can be selected and applied to image data based on a type of produce that is being imaged over a predetermined period of time. The one or more of the models can also be selected based on one or more features of interest (e.g., quality features) described throughout this disclosure, including but not limited to color, volume, wrinkles, internal rot, etc.

FIG. 2B is a conceptual diagram for training one or more models to determine shelf life of the produce based on identified changes in quality features over time. For example, the one or more models can be trained to analyze changes in quality features that were identified by application of the models of FIG. 2A and determine a duration score for the produce. In some implementations, instead of or in addition to machine learning models, the computer system can develop algorithms to analyze changes in quality features over time and determine a duration score for the produce. Training and model generation can be performed by the computer system 110. In some implementations, training and model generation can be performed by one or more other computing systems, devices, cloud-based services, and/or network of computers and/or devices.

The computer system 110 can receive produce training data 200 (A). The produce training data 200 can optionally include produce image data 202, produce spectral data 204, and destructive measurements data 206 (e.g., refer to FIG. 2A). The produce training data 200 can include produce feature model(s) output 208. Thus, the computer system 110 can train one or more models to identify, based on the produce feature model(s) output 208 (e.g., refer to FIG. 2A), quality changes over time and a corresponding duration score for the particular produce.

Accordingly, the computer system 110 can identify duration scoring based on the produce feature model(s) output 208 (B). The computer system 110 can identify duration scoring for both treated and untreated produce of different types of produce. The computer system 110 can correlate changes in quality features at different time periods with different stages and/or levels of duration (e.g., ripeness, shelf life, salability, edibility) to therefore identify duration scoring for a particular produce. The computer system 110 can also train the one or more models to determine a shelf life extension factor based on the duration scoring in step C. Duration scoring, as described herein, can indicate how much longer produce has of shelf life, how long the produce's total shelf life is, etc.

The computer system 110 can then output the generated and trained models for the identified duration scoring (D). Outputting the models can include storing the models in a database, data store, and/or cloud storage. Outputting the models can also include maintaining the models in local memory and/or storage such that they can be easily and quickly retrieved and applied during runtime. Accordingly, during runtime, one or more of the models can be selected and applied to image data based on a type of produce that is being imaged over a predetermined period of time.

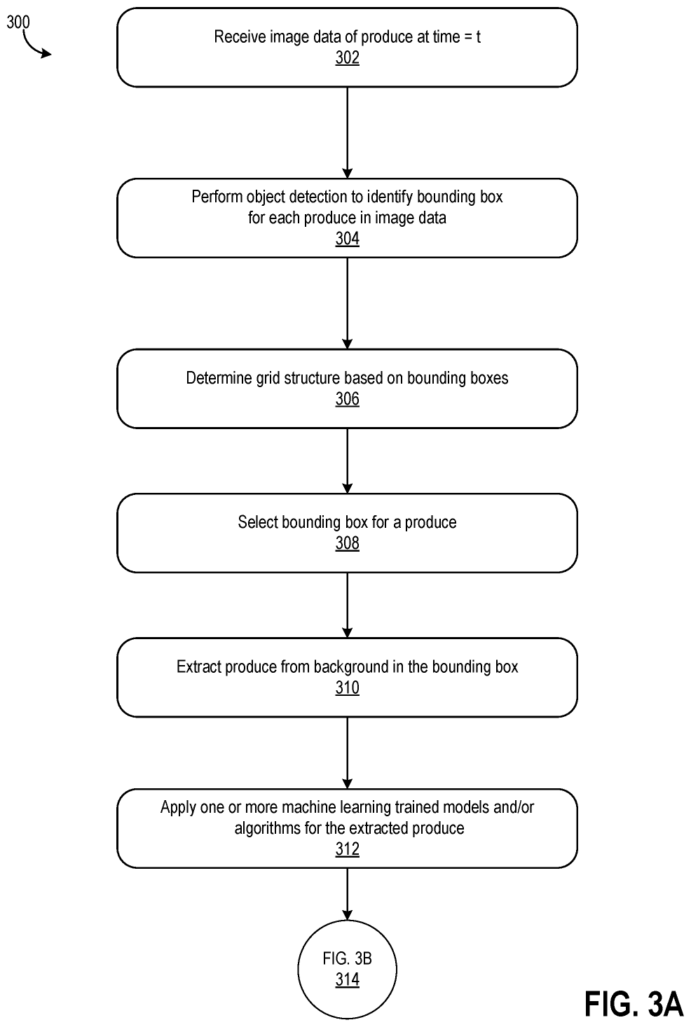

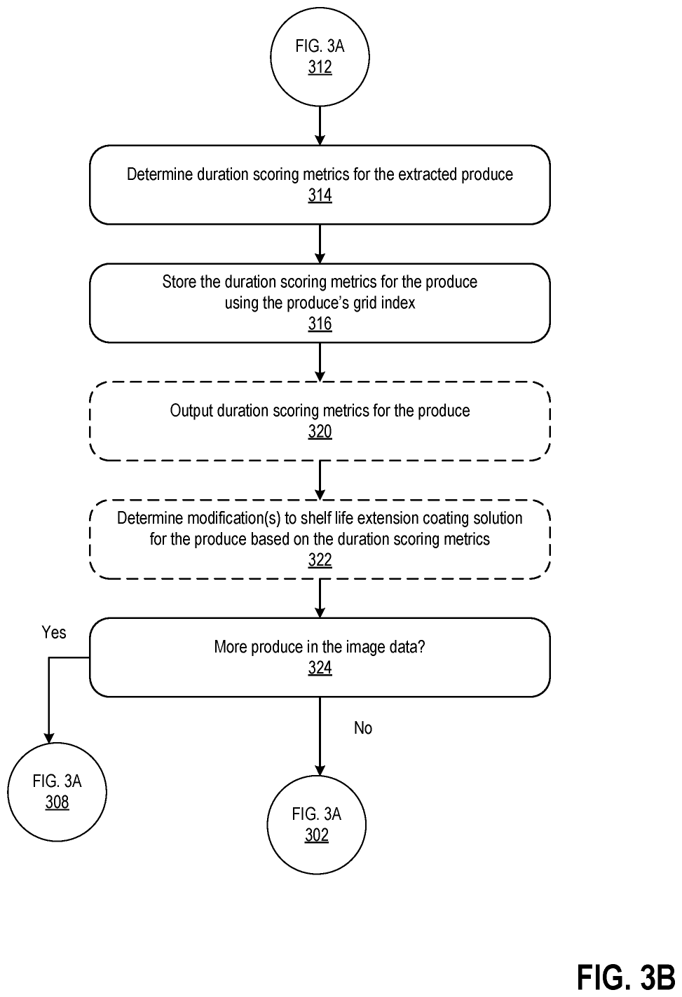

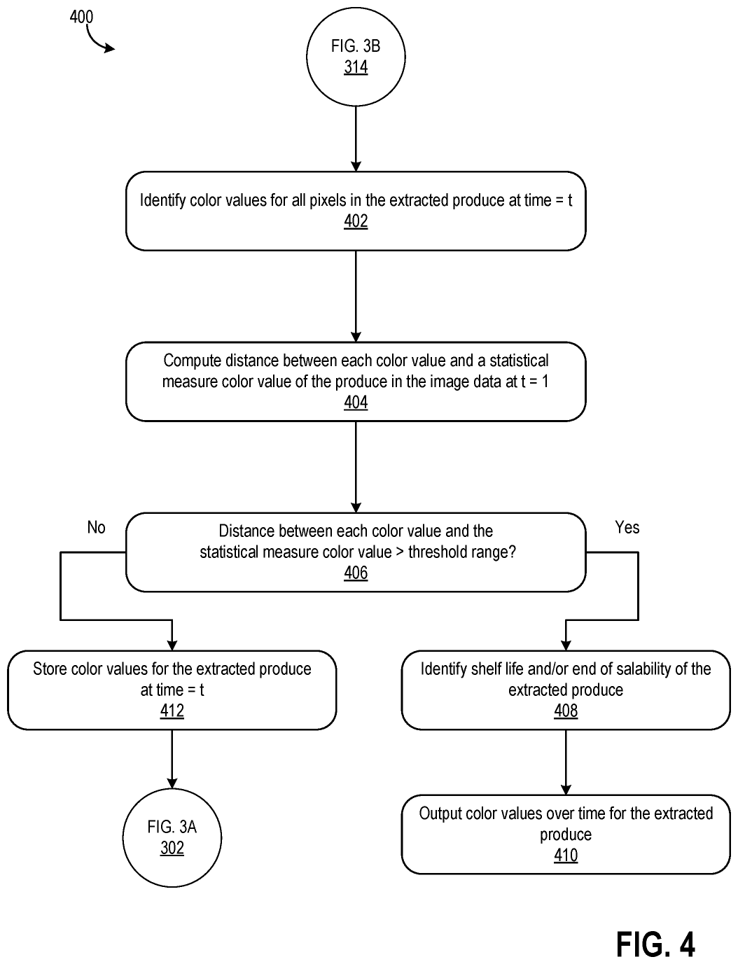

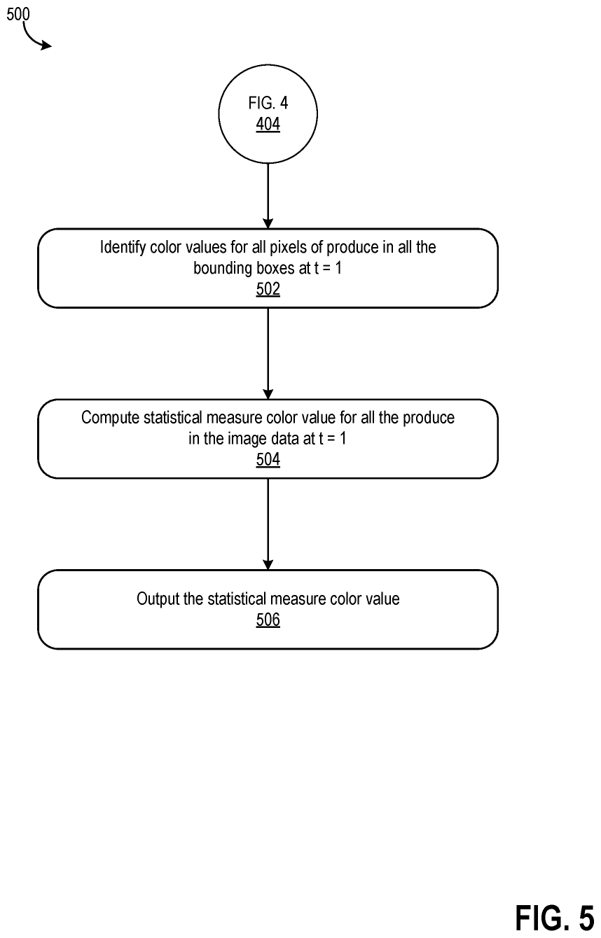

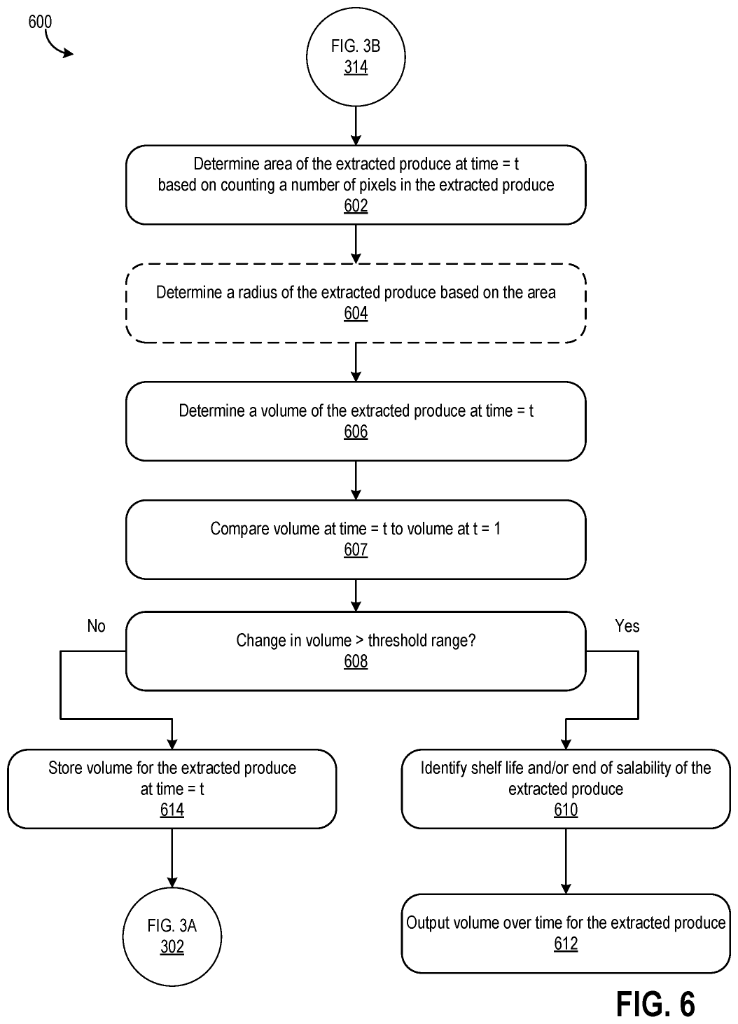

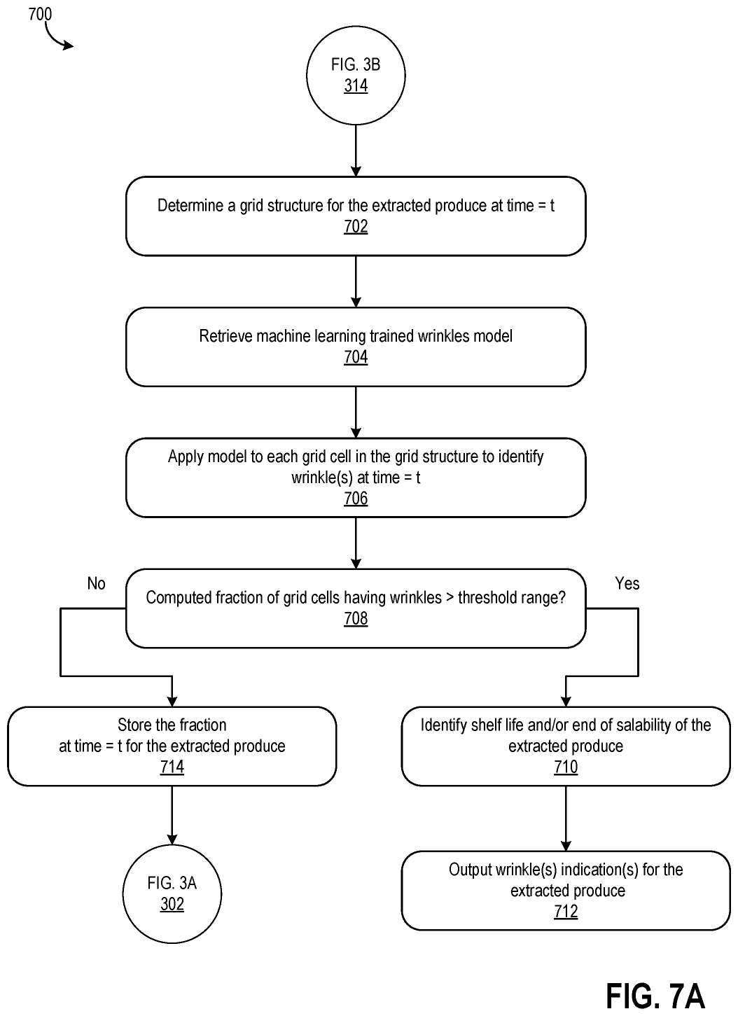

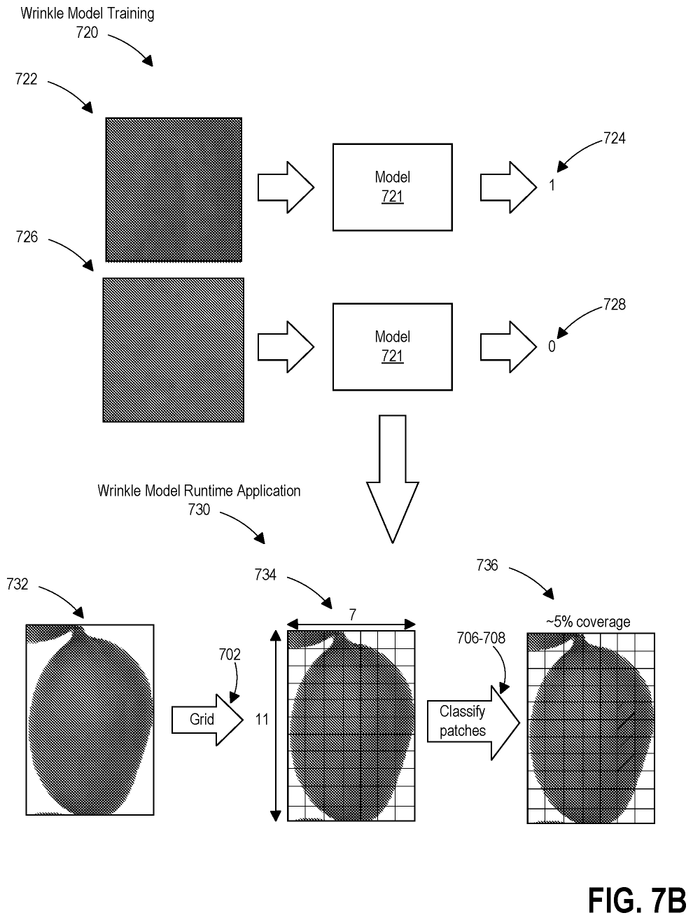

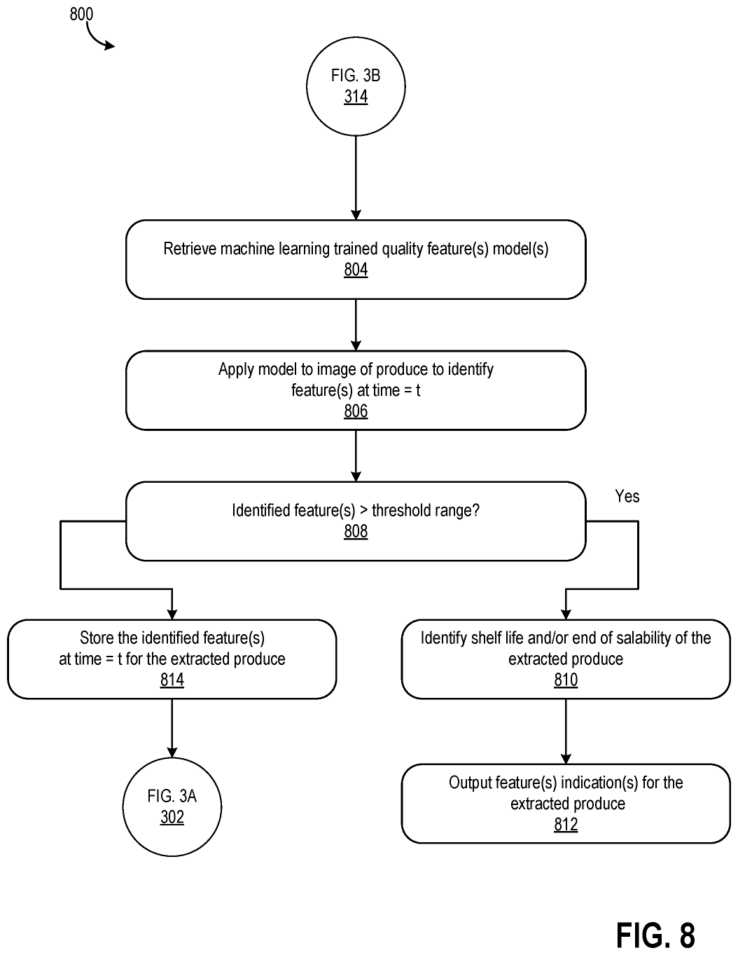

FIGS. 3A-B is a flowchart of a process 300 for determining shelf life of produce. The process 300 can be performed by the computer system 110. The process 300 can also be performed by one or more other computers, computer systems, devices, cloud-based services, and/or network of computers and/or devices. For example, the process 300 can be performed by an edge computing device. For illustrative purposes, the process 300 is described from a perspective of a computer system.

Referring to the process 300 in both FIGS. 3A-B, the computer system can receive image data of produce at time=tin 302. Time=t can be at constant time intervals throughout a period of time when a time lapse image data is being captured of the produce. In some implementations, citrus fruits can be imaged for a period of time of 70 to 90 days. Avocados and similar produce can be imaged for a period of time of 30 days. Apples can be imaged for a period of time of 80 to 100 days. One or more other periods of time can also be used to image the produce based on a type of the produce and/or particular features of interest for that produce, as previously described. For example, the produce can be imaged for a period of time of 30 days. During the 30 days, every 24 hours, image data of the produce can be captured. Thus, time=t can be 0 hours, 24 hours, 48 hours, 72 hours, etc. Time=t can also be any other time interval at which image data of the produce may be captured during the period of time (e.g., 5 times a day for the entire period of time, 7 times a day for the entire period of time, etc.).

When the process 300 begins for produce that is being imaged for the first time, time=t can be 0 hours, or a time at which the produce is first imaged. As described herein, the process 300 can repeat for each time=t at which image data is captured of the produce, until the period of time for imaging the produce (e.g., 30 days for some types of produce such as avocados) ends. Throughout the period of time that the produce is imaged, the produce may not be moved from the imaging environment. When the image data is captured at each time=t, lighting, camera conditions, and placement of the produce remain constant. This can be advantageous to ensure that produce are imaged similarly at each time interval to provide for more accurate comparison and analysis of quality changes over time.

The image data can be any type of image data described herein, including but not limited to 2D images, thermal images, hyperspectral images, and/or video feeds. Hyperspectral images can be beneficial to identify and quantify quality features of the produce that may not be readily visible with human observation. For example, hyperspectral images can be beneficial to identify and quantify internal and external bruising, internal and external infection, rot, dry matter, and pH. RGB images (e.g., 2D images) can, for example, be beneficial to identify and quantify features such as color, volume, and wrinkles.

Treated and untreated produce of a same type can be captured in the image data. Treated produce can be coated in a shelf life extension coating solution, as described herein. Using the disclosed techniques, quality changes that are identified and quantified in the treated produce can be compared to quality changes that are identified and quantified in the untreated produce. Such a comparison can be beneficial to analyze and/or modify the shelf life extension coating solution such that it can improve duration (e.g., ripeness, shelf life, edibility, salability) of treated produce. This comparison can also be beneficial to benchmark performance of the shelf life extension coating solution and to objectively compare the shelf life extension coating solution to other solutions.

In 304, the computer system can perform object detection techniques to identify a bounding box for each produce in the image data. Object detection algorithms and/or machine learning trained models can be applied to the image data to identify objects indicative of produce in the image data. A bounding box can be formed around each of the identified objects. In some implementations, the computer system may not identify the produce category or type of the produce in the image data. Instead, the object detection algorithms and/or machine learning trained models can detect any object that is produce in the image data. In yet some implementations, the computer system can identify the produce or type of produce when identifying the bounding boxes for each produce in the image data.

The computer system can also determine a grid structure based on the bounding boxes in 306. Determining the grid structure can include assigning identifiers to each bounding box in the image data. The identifiers can be used to identify each of the produce in the image data and associate quality changes found in each bounding box with the respective produce. For example, a first bounding box can be a first cell in the grid structure, which can be assigned an identifying value of 0. As another example, a second bounding box can be a second cell in the grid structure, which can be assigned a value of 1. Produce in the first bounding box can be identified via the grid index 0 and produce in the second bounding box can be identified via the grid index 1. In some implementations, a coordinate system can be used to annotate or index locations of each of the produce in the image data. Numerical values can be used to represent locations of the produce in the image data. For example, a bounding box for a produce can have four numerical values, such as (xmin, xmax, ymin, ymax) or (x, y, width, height). Subsequent processing steps can use the numerical values that represent the locations of the produce to determine outer boundaries of each of the produce and particular duration scoring metrics (e.g., quality attributes) of the produce.

The computer system can then select a bounding box for a produce in 308. After all, the computer system can identify quality changes in each of the produce in the image data at time=t. The computer system can determine an overall quality change for the produce based on aggregating the quality changes of each individual produce. More particularly, the computer system can determine overall quality changes for the treated produce and overall quality changes for the untreated produce. Those overall quality changes can then be compared to analyze the effects of the shelf life extension coating solution on duration of produce (e.g., shelf life, length of time that the produce is fresh, ripe, or otherwise desirable for human consumption).

Next, the computer system can extract the produce from a background in the bounding box (310). In some implementations, the computer system can implement techniques, algorithms, and/or models to identify a channel in which the foreground can be separated from the background by thresholding to obtain a mask. The mask can then be applied to the full image (e.g., 3 channel image) to extract the foreground that represents the produce. As an illustrative example, each channel can include [0-255] numerical values for each x,y location in the grid structure. A blue channel, for example, can separate avocados from the background well since avocados do not have much blue in them but the background does. Thus, in the blue channel, avocado pixels can get low values closer to 0 while the background can get higher values, such as 150 and other values closer to 255. A threshold can be identified around 80, as an illustrative example, which can be applied to create a binary mask of all the pixels in the image with a value less than 80. The mask can be applied to the full image to cut out the RGB pixels on the avocado.

In some implementations, the computer system can implement techniques, algorithms, and/or models to optionally map all RGB values in the bounding box into 3D space or other color spaces, identify clusters of RGB values, select a cluster or clusters indicative of the produce, and then extract the selected cluster or clusters from the image data. For example, the computer system can train a clustering model to predict a cluster number for each data point in 3D space. Depending on clustering techniques used, clustering can be based on spheres in 3D space (e.g., k-means clustering) and/or more complex multidimensional Gaussians (e.g., Gaussian Mixture Model).

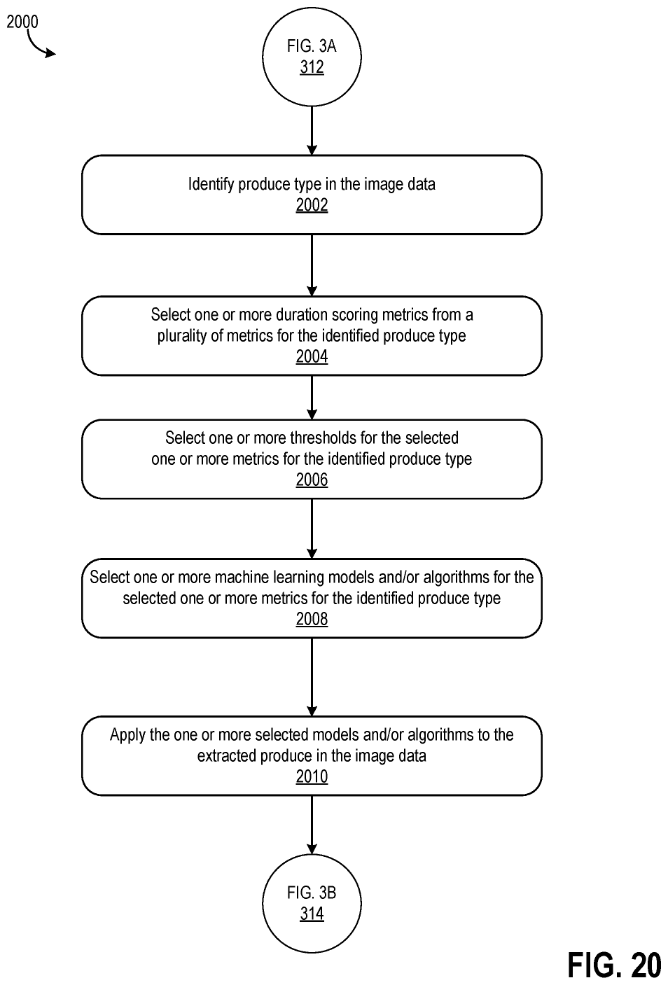

In 312, the computer system can apply one or more machine learning trained models for the extracted produce. The computer system can select one or more models to apply to quantify quality changes in the produce. The computer system can select the models based on a type of produce that is imaged. Refer to FIG. 20 for further discussion. In some implementations, the computer system can select one or more algorithms to apply to assess and quantify the quality changes in the produce, in addition to or instead of the machine learning models. The computer system can also identify one or more threshold levels for the particular type of produce that are indicative of duration (e.g., end of shelf life, end of salability, etc.), as previously described. Once the models, algorithms, and/or thresholds are selected, they can be applied to the extracted produce in the bounding box in the image data in block 312. In some implementations, the models, algorithms, and/or thresholds can be selected once, when the produce is imaged for the first time (e.g., at time=0 hours or time=1 hour). The same models, algorithms, and/or thresholds can then be applied to every subsequent image data that is captured of the produce during the period of time that the produce is imaged. Moreover, the same models, algorithms, and/or thresholds can be applied to treated and untreated produce in the image data.

The computer system can determine duration scoring metrics for the extracted produce at time=t (314). The duration scoring metrics can be determined based on application of the models and/or algorithms for the particular produce. The duration scoring metrics can be determined based on analysis of the pixels in the image data that represents the extracted produce. As described further below, the duration scoring metrics can be a variety of quality attributes that change over time. The duration scoring metrics can therefore include changes in firmness, color, volume, rot, desiccation, wrinkles, and other external and internal quality features. Changes in color can show quality of produce and, for example, when the produce has reached a color that deters consumers from buying the produce (e.g., when a lime turns yellow, consumers are less likely to purchase it). As another example, when the produce shrinks over time (e.g., volume of the produce decreases), the produce is decaying and therefore is becoming less desirable for purchase and consumption by consumers. These are example duration scoring metrics that can be quantified using the techniques described herein.

In some implementations, the computer system can determine one duration scoring metric, such as color. In yet some implementations, the computer system can determine multiple duration scoring metrics, such as color and volume. A number of duration scoring metrics that are determined can depend on a type of produce that is captured in the image data. Refer to FIGS. 4, 6, 7A-B, and 8 for further discussion about determining the duration scoring metrics.

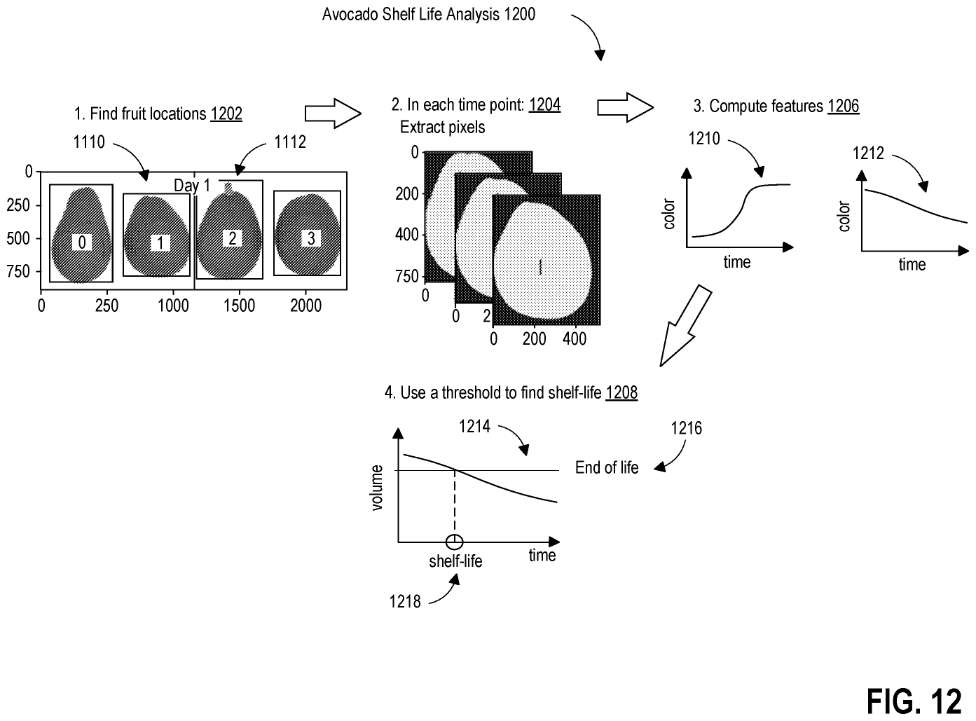

The computer system can then store the duration scoring metrics for the produce using the produce's grid index in 316. The computer system can retrieve the duration scoring metrics at a later time to analyze changes in the duration scoring metrics over the period of time for the particular produce. For example, the computer system can retrieve the duration scoring metrics for both treated and untreated avocados over 30 days that the same batch of treated and untreated avocados are imaged. The computer system can graph the duration scoring metrics for both treated and untreated avocados in a curve plot, histogram, or similar graphical depiction. The computer system can then compare the graphed duration scoring metrics to identify how treated produce's duration changes or is improved in comparison to the untreated produce (e.g., refer to FIGS. 12 and 14).

Optionally, the computer system can output the duration scoring metrics for the produce (320). The computer system can transmit the duration scoring metrics to a user device (e.g., refer to FIGS. 1 and 10) for presentation in a GUI on a display screen of the user device. In some implementations, the computer system can be the same as the user device, and the computer system can merely output the duration scoring metrics at a display screen of the computer system.

As described throughout this disclosure, the duration scoring metrics can be outputted in a curve plot, histogram, or other similar graphical depiction (e.g. refer to FIGS. 12, 14-18). Outputting the duration scoring metrics can be advantageous to have a visual representation of quality changes over time for both the treated and untreated produce of the same type over the period of time that the produce is imaged. Such a visual representation can advantageously depict how duration of the treated produce is extended in comparison to duration of the untreated produce.

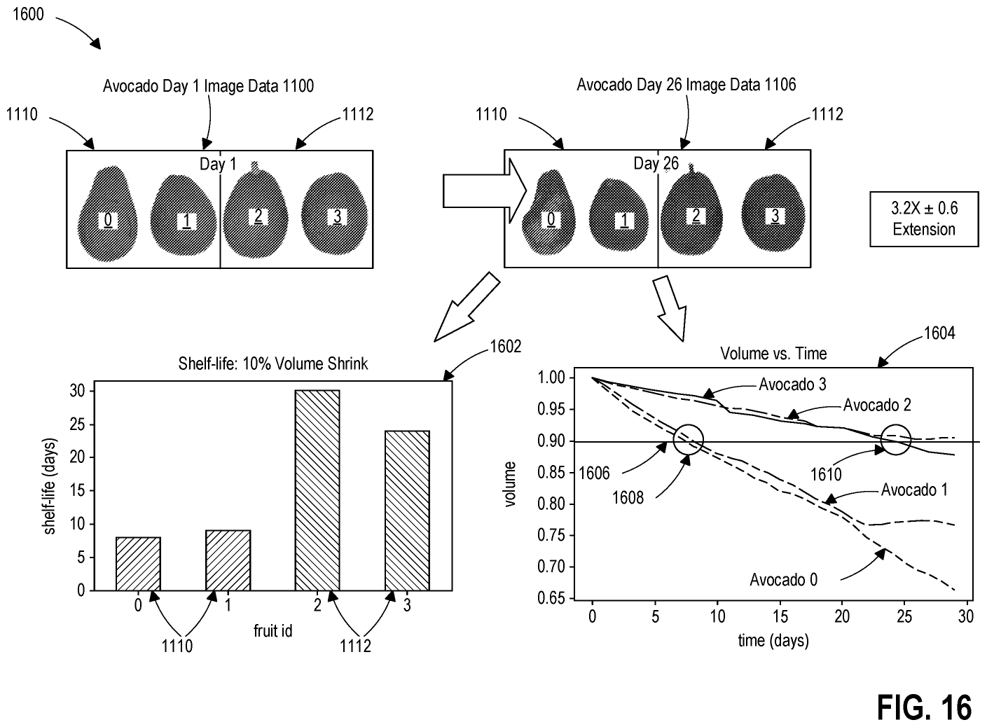

In some implementations, outputting the duration scoring metrics can also include determining and outputting an extension factor. The extension factor can be a multiplication factor indicating how much more duration is extended for treated produce in comparison to untreated produce. In other words, the extension factor can be an average of shelf life ratios (e.g., duration scoring metrics) of treated and untreated produce over a statistically representative set of the produce (e.g., refer to FIGS. 16-17, 19).

In yet some implementations, outputting the duration scoring metrics can include determining an overall duration score for treated produce and an overall duration score for untreated produce. The overall duration scores can then be outputted and presented to the relevant stakeholder and used to analyze how the shelf life extension coating solution improves the duration of the treated produce. For example, the overall duration scores can be used to determine how much the shelf life is extended for each individual duration metric. As an illustrative example, the relevant stakeholder can determine that in terms of color retention, the shelf life extension coating solution does well, but in terms of volume retention, the shelf life extension coating solution can be improved to retain volume for longer in the treated produce.

Optionally, the computer system can also determine modifications to a shelf life extension coating solution for the produce based on the duration scoring metrics (322). When the period of time for imaging the produce is complete, the computer system can determine whether modifications can or should be made to the shelf life extension coating solution that was applied to the treated produce in the image data. For example, block 322 can be performed when time=t is the last day and/or last hour of the period of time (e.g., day 30 of 30 days of imaging the produce).

In some implementations, block 322 can be performed throughout the period of time that the produce is imaged, for example at predetermined time intervals. For example, if the produce is being imaged over 30 days, every 5 days the computer system can determine whether modifications should be made to the coating solution.

When modifications are determined in block 322, the modifications can be implemented (e.g., manually by the relevant stakeholder in the supply chain and/or semi-autonomously by the computer system or another computer system). The modifications can be implemented in real-time, when they are determined. The modifications can also be implemented at a later time. Implementing the modifications can include altering a composition of the shelf life extension coating solution. Implementing the modifications can also include applying a different concentration of the coating solution to subsequent batches of produce of the same and/or different type as the produce that is imaged. The coating solution modifications can be implemented for batches of produce that have not been imaged. For example, the modified coating solution can be applied to produce that is being shipped out of a storage facility and transported to end consumers in retail environments. Applying the modified coating solution to the produce can be beneficial to improve that produce's duration (e.g., ripeness, shelf life, edibility, salability). Improved duration can improve consumer satisfaction, benefit retail environments, and lead to reduced produce-based waste. Modifying the shelf life extension coating solution can be beneficial to optimize duration of produce (e.g., shelf life, length of time that the produce is fresh, ripe, or otherwise desirable for human consumption). Moreover, improving duration scores and shelf life extension ratios can bolster claims that the shelf life extension coating solution in fact improves duration of produce.

Still referring to the process 300, the computer system can determine whether there is more produce in the image data at time=t (324). If there is more produce in the image data, the computer system can return to block 308 and repeat the blocks 308-322 for any of the remaining produce in the image data. Thus, the computer system can determine duration scoring metrics for each produce in the image data. The computer system can also determine an aggregate duration scoring metric for treated produce and an aggregate duration scoring metric for untreated produce in the image data at time=t. If there are no more produce in the image data, then the computer system can return to block 302 and repeat the blocks 302-322 for all remaining time periods (e.g., t=24 hours, 48 hours, 72 hours, etc.) during the period of time (e.g., 30 days, 35 days, 40 days, 45 days, 50 days, etc.) that the produce is imaged. The computer system can therefore repeat the process 300 until the produce is imaged for the period of time.

FIG. 4 is a flowchart of a process 400 for determining a color quality metric for produce. The process 400 can be performed as part of determining duration scoring metrics for the extracted produce in block 314 of the process 300 in FIGS. 3A-B. In other words, the duration scoring metric for a particular produce can be a color quality metric, which is determined using the process 400. The process 400 can be performed by the computer system 110. The process 400 can also be performed by one or more other computers, computer systems, devices, cloud-based services, and/or network of computers and/or devices. For example, the process 400 can be performed by an edge computing device. For illustrative purposes, the process 400 is described from a perspective of a computer system.

Referring to the process 400, the computer system can identify color values for all pixels in the extracted produce at time=t (402). The computer system can identify a color value for each pixel of the extracted produce. In some implementations, the computer system can determine an average color value for all the pixels that represent the extracted produce.

The computer system can compute the distance between each color value and a statistical measure (e.g., mean, mode, median, or some other quantile of distribution) color value of the produce in the image data at t=1 (404). Distance can be computed as Euclidean distance. The computer system can compare the color values on a pixel by pixel basis by comparing the color value of each pixel to the statistical measure color value. In some implementations, the computer system can compare the average color value for all the pixels to the statistical measure color value at t=1.

The statistical measure color value can represent, in some implementations, an average color of the produce when the produce was first imaged, which is t=1. Refer to FIG. 5 for further discussion about the statistical measure color value of the produce. By computing the distance between each color value and the statistical measure color value of the produce, the computer system can determine how much the color of the produce has changed at each time=t since t=1 (when the produce was first imaged). The changes in color over time can indicate the duration of the produce, as described herein.

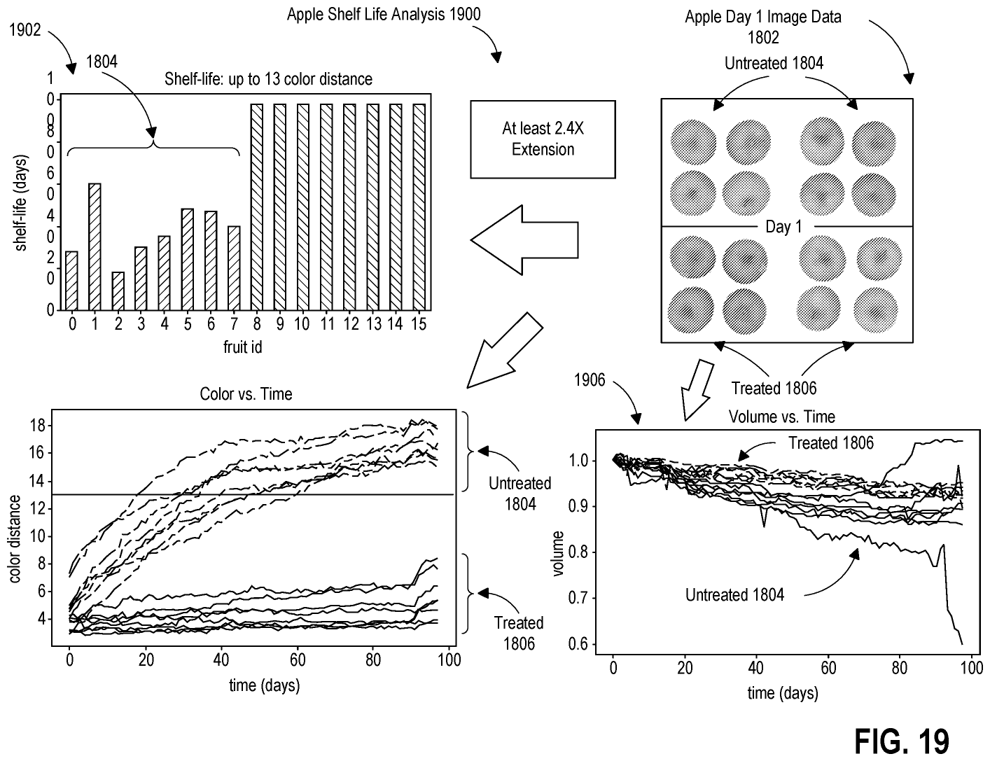

The computer system can then determine whether a distance between each color value and the statistical measure color value exceeds a threshold range (406). The threshold range can be determined based on each produce category. Analysis can be performed to determine ranges of colors that are edible and/or salable for the particular produce. A smaller distance can indicate less change in color from t=1 (when the produce was first imaged) to time=t (whatever time interval the image data is captured). Less change in color can indicate a longer duration (e.g., longer shelf life, edibility, salability). A greater distance can indicate more change in color from t=1 to time=t. More change in color can indicate a shorter duration (e.g., shorter shelf life, edibility, salability). More change in color can therefore indicate that the produce is reaching the end of its duration (e.g., the produce is aging and therefore reaching the end of its shelf life). When using color distance, the threshold range can be set based on distance between the initial statistical measure color value and the threshold color (where the threshold color can be determined based on analysis of the produce category). For example, for granny smith apples (as shown in FIG. 19), the end of shelf life can be identified as a time once the apples turn yellow. This information can be used to compute the distance between the day 1 green color of the apples and the yellow color that determines the end of the apples' shelf life. This computed distance can be used as the threshold range for the color distance described herein.

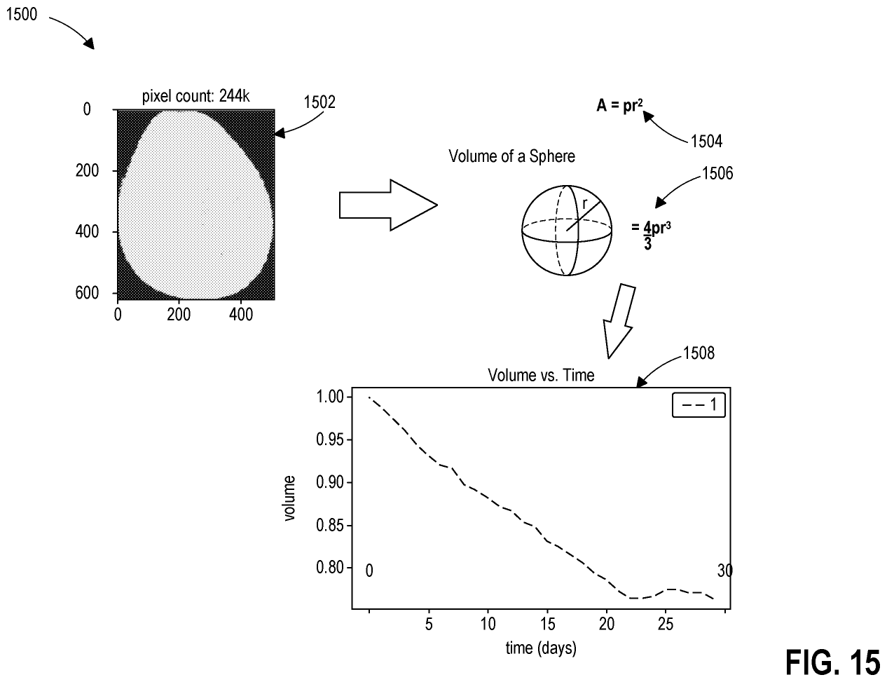

In some implementations, in addition to or instead of determining whether the distance between each color value and the statistical measure color value exceeds the threshold range, the computer system can output the distances in a graphical depiction (e.g., a curve plot as shown in FIGS. 15-19, histogram, line graph, etc.). The computer system can then determine changes in the color values over time, at each of the different time=t during the period of time. In some implementations, a user can analyze the graphical depiction and determine changes in the color values over time. By visually depicting the changes in color values over time, the user can easily compare duration of treated produce to untreated produce.

If the distance between each color value and the statistical measure color value exceeds the threshold range in 406, then the computer system can identify shelf life and/or end of salability of the extracted produce in 408. In other words, the distance can be so great that the produce is no longer desirable for purchase and/or consumption by consumers. In some implementations, the computer system may not make this determination until after the produce is imaged for the entire period of time (e.g., all 30 days for avocados). The computer system can then make this determination by comparing the distances that are determined and outputted in the graphical depiction at each time=t during the period of time.

In some implementations, the computer system may use absolute color as a metric instead of the color distance described above. The computer system can then monitor how the color of the produce moves in 3D color space to determine whether the color moved into an unsalable domain.

The computer system can also output the color values over time for the extracted produce in 410. As mentioned above, the computer system can output the color values and/or the distances between each color value and the statistical measure color value in a graphical depiction, such as a line graph and/or histogram. The graphical depiction can be preferred by the user to easily identify and quantify differences in duration for treated and untreated produce.

Referring back to 406, if the distance does not exceed the threshold range, then the computer system can store the color values for the extracted produce at time=t (412). In other words, the computer system can determine that the produce's color has not deviated so much from the original color of the produce at t=1 to identify the produce as reaching the end of its duration. Optionally, and as described above, the computer system can also output the color value and/or the distance in the graphical depiction. The graphical depiction can demonstrate color changes over time for both treated and untreated produce. The computer system can then return to block 302 in the process 300 of FIGS. 3A-B. The process 400 can be repeated to determine color changes over time for each of the produce in the image data at time=t. As mentioned above, in some implementations, the process 400 can be performed to determine an average color change over time for the treated produce in the image data at time=t and an average color change over time for the untreated produce in the image data at time=t.

Moreover, in some implementations, the process 400 can be performed using one or more machine learning models. In yet some implementations, the process 400 can be performed using one or more algorithms or other computer processes and/or techniques.

FIG. 5 is a flowchart of a process 500 for determining a statistical measure color value for produce, such as a mean color value. As described above, the process 500 can be performed once when the produce is imaged for the first time (e.g., at t=1, which can be a first day of 30 days of imaging). The first time, t=1, can represent the beginning of the produce's duration, such as the beginning of its ripeness period, shelf life, edibility, and/or salability. The first time, t=1, can also represent any other time in the produce's life cycle when it is first imaged using the techniques described herein. The statistical measure color value can be used to compare how much the color of the produce deviates from t=1 at each time interval when the produce is imaged, throughout its duration (e.g., the period of time).

The process 500 can be performed as part of block 404 in the process 400 of FIG. 4. The process 500 can be performed by the computer system 110. The process 500 can also be performed by one or more other computers, computer systems, devices, cloud-based services, and/or network of computers and/or devices. For example, the process 500 can be performed by an edge computing device. For illustrative purposes, the process 500 is described from a perspective of a computer system.

Referring to the process 500, the computer system can identify color values for all pixels of produce in all the bounding boxes of the image data at t=1 (502). For example, when the produce is imaged for the first time, the computer system can apply one or more models and/or algorithms to the image data to extract the pixels that identify the produce. The computer system can identify the color values for pixels of both treated and untreated produce in the image data. Therefore, subsequent color changes of both the treated and untreated produce can be compared to the same statistical measure color value.

The computer system can then compute a statistical measure color value for all the produce in the image data at t=1 (504). The computer system can average all of the identified color values from block 502. In some implementations, the computer system can also find the mean of all the identified color values from block 502. In some implementations, the computer system can compute a mean, median, quantile, or other metric of each produce separately. The computer system can then track a distance of the metric for each produce from the produce's statistical measure color value at t=1. In yet another implementation, the computer system can compute, at each time t, a median of pixel by pixel distances of each produce from its own pixel by pixel colors at t=1. Therefore, instead of averaging a color over pixels and then computing a distance between the averaged values, the computer system can compute a distance of each pixel relative to the value the pixel had at t=1, which can provide a matrix of distances that can then be reduced to a single number by taking a mean, median, or other quantile metric. One or more other mathematical processes can be used to determine the statistical measure color value for the treated and untreated produce.

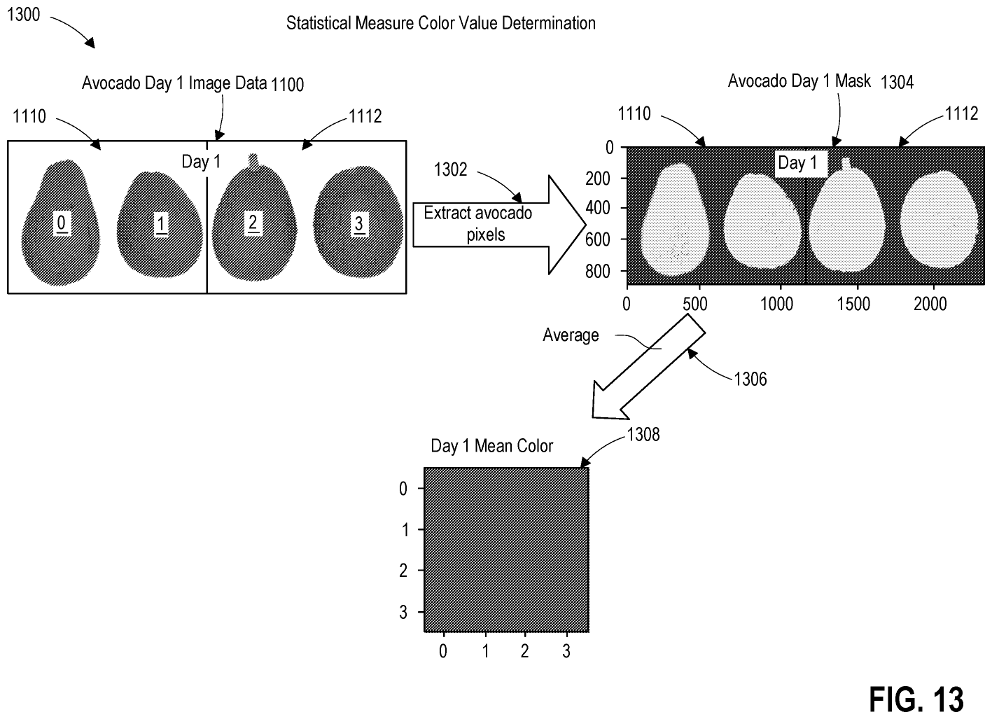

The computer system can output the statistical measure color value in 506. As described above, the statistical measure color value is then used in the process 400 to compare color changes of the produce over time to the statistical measure color value. How much the color of the treated and untreated produce deviates from the statistical measure color value over time can dictate a duration score of each of the treated and untreated produce, such as how much shelf life remains for the treated and/or untreated produce. Refer to FIG. 13 for further discussion about determining the statistical measure color value.

FIG. 6 is a flowchart of a process 600 for determining a volume quality metric for produce. The process 600 can be performed as part of determining duration scoring metrics for the extracted produce in block 314 of the process 300 in FIGS. 3A-B. For example, the duration scoring metric that is determined using the process 600 can be a change in volume of the produce (e.g., % shrink of the produce over time). In some implementations, the process 600 can be performed to identify a volume of the produce at t=1, when the produce is first imaged (e.g., at day 1). Using the process 600, a computer system can then determine volume of the produce at each time interval of imaging then compare the determined volume to the volume of the produce at t=1. The computer system can also output the changes in volume over time, for example in a line graph, histogram, or other graphical depiction, as described throughout this disclosure.

The process 600 can be performed to identify a change in volume for each of the produce in the image data. The process 600 can also be performed to identify an average change in volume for the treated produce and an average change in volume for the untreated produce. As described throughout, the average change in volume of the treated produce can be compared over time to the average change in volume of the untreated produce in order to quantify how applying the shelf life extension coating solution to the treated produce impacts (e.g., improves) the treated produce's duration. The shelf life extension coating solution can retain quantities of water and block oxygen from penetrating the produce. Thus, the shelf life extension coating solution can prevent oxidation and loss of water, which means the produce shrinks (e.g., loses volume) at a slower rate than produce that is untreated. Determining change in volume can be an important and useful factor for identifying duration (e.g., shelf life) of produce. Volume can be a good indicator of duration for some types of produce, such as citrus fruits (e.g., lemons and limes) and produce like avocados.

The process 600 can be performed by the computer system 110. The process 600 can also be performed by one or more other computers, computer systems, devices, cloud-based services, and/or network of computers and/or devices. For example, the process 600 can be performed by an edge computing device. For illustrative purposes, the process 600 is described from a perspective of a computer system.

Referring to the process 600, the computer system can determine an area of the extracted produce at time=t (602). The area can be determined based on counting a number of pixels in the extracted produce. For example, the computer system can apply an algorithm that, once the produce is extracted from the background of the image data in the process 300, counts the number of pixels that were extracted for the particular produce.

Optionally, the computer system can determine a radius of the extracted produce based on the area (604). The computers system can model a shape of the produce in order to accurately compute the volume of the produce. For example, for a straight cucumber, the cucumber can be fitted to an ellipse in 2D space to then compute a volume of an ellipsoid. Alternatively, the cucumber can be modeled as a rectangle in 2D space and then the volume can be computed for a cuboid. In some example implementations, the radius can be found using the formula Area=πr². This formula can be used for spherical produce or other produce that can be approximated to a spherical shape, such as citrus fruits, apples, and some avocados. The computer system can then use the formula and solve for the radius. The computer system can determine a volume of the extracted produce at time=t (606). For example, once the computer system optionally identifies the radius in 604, the computer system can determine a volume of the extracted produce at time=t (606). As mentioned above, the computer system can use a volume formula for spheres. The computer system can solve for the volume using the formula V=4/3πr³. The computer system can use spherical area and volume formulas for produce that is relatively round, such as avocados, apples, limes, lemons, and other similar produce. One or more other area and volume formulas can be selected and utilized depending on a relative shape of the produce.

The computer system can compare the volume at time=t to the volume of the produce at t=1 (607). As mentioned above, at t=1, when the produce is first imaged, the produce can be at 100% its volume. Over time, the produce shrinks. As an example, the produce can be 98% its original volume on a second day of imaging. The produce can be 90% of its original volume on a fourth day of imaging, and so on. Thus, the computer system can analyze and/or determine relative volume of the produce compared to the starting volume over the period of time that the produce is imaged. In some implementations, comparing the volume at time=t to the volume of the produce at t=1 can include outputting the volume per time period that the produce is imaged in a graphical depiction, such as a line graph (e.g., refer to FIGS. 12, 15). Comparing the volume at time=t to the volume of the produce at t=1 can also include outputting the percent change in volume per time period that the produce is imaged in a graphical depiction, such as a line graph.

The computer system can determine whether the change in volume exceeds a threshold range in 608. In other words, the computer system can determine if the produce has shrunk a predetermined amount that signifies the produce is nearing or at the end of its duration (e.g., ripeness, shelf life, edibility, and/or salability). Moreover, the computer system can make such a determination for both the treated produce and the untreated produce. As a result, the computer system and/or a relevant stakeholder can compare the effects that the shelf life extension coating solution has on improving duration of the produce.

If the change in volume exceeds the threshold range, then the computer system can identify a shelf life and/or end of salability of the extracted produce in 610. As mentioned above, the computer system may determine that the produce has reached or is reaching the end of its duration. The produce, after all, has shrunk or diminished in volume/size so much that it no longer is desirable for purchase and/or consumption by consumers.

The computer system can also output the volume over time for the extracted produce in 612. As mentioned above, the computer system can output the percent change in volume since t=1 in a graphical depiction, such as a line graph. Refer to FIGS. 12 and 15 for further discussion.

If the change in volume does not exceed the threshold range in 608, then the computer system can store the volume for the extracted produce at time=t (614). The stored change in volume can later be retrieved, compared, and/or analyzed with changes in volume for both treated and untreated produce of the same type at different time periods. The computer system may also output the changes in volume for the treated and untreated produce in the graphical depiction to provide a visual comparison of the effects of treating the produce with the shelf life extension coating solution. The computer system can then return to block 302 in the process 300.

In some implementations, the process 600 can be performed using one or more machine learning models. In yet some implementations, the process 600 can be performed using one or more algorithms or other computer processes and/or techniques.

FIG. 7A is a flowchart of a process 700 for determining a wrinkle quality metric for produce. The process 700 can be performed as part of determining duration scoring metrics for the extracted produce in block 314 of the process 300 in FIGS. 3A-B. Therefore, a computer system can determine a duration of the produce based on whether the produce exhibits wrinkles and/or how much of the produce is wrinkled. The more wrinkled the produce, the closer the produce is to the end of its duration (e.g., end of ripeness, shelf life, edibility, salability). As described throughout this disclosure, the computer system can determine how wrinkled each produce is, including treated produce and untreated produce. In some implementations, the computer system can determine an average wrinkle indication for all the treated produce that is imaged and an average wrinkle indication for all the untreated produce that is imaged. The process 700 can be performed to identify how applying the shelf life extension coating solution to the produce (e.g., the treated produce) can cause the produce to develop wrinkles at a slower rate than untreated produce, thereby increasing the produce's duration.

The process 700 can be performed by the computer system 110. The process 700 can also be performed by one or more other computers, computer systems, devices, cloud-based services, and/or network of computers and/or devices. For example, the process 700 can be performed by an edge computing device. For illustrative purposes, the process 700 is described from a perspective of a computer system.

Referring to the process 700 in FIG. 7A, the computer system can determine a grid structure for the extracted produce at time=t (702). As another example, the computer system can annotate wrinkles on the entire produce image to create a Boolean mask of the wrinkled locations. An image segmentation model can then be trained to predict the Boolean mask (and thus the wrinkled locations). Using the model predictions, a fraction of wrinkled area for the produce can be computed. Once the computer system extracts the produce from the background in the image data in the process 300 in FIGS. 3A-B, the computer system can generate a grid structure for that produce, where each grid is assigned a grid index and each grid overlays a portion of the produce.

The computer system can retrieve a machine learning trained wrinkles model in 704. Wrinkles models can be generated and trained for each different type of produce that may develop wrinkles. For example, one wrinkles model can be generated and trained for mangos. Another wrinkles model can be generated and trained for bell peppers.

In 706, the computer system can apply the model to each grid cell in the grid structure to identify one or more wrinkles at time=t. The model, as described further in FIG. 7B, can be trained to identify whether one or more wrinkles are present in each grid in the grid structure that makes up the image data of the produce. When wrinkles are identified in a grid, the grid can be assigned a corresponding value, such as 1 for wrinkle(s) and 0 for no wrinkle(s). One or more other values can also be assigned, including but not limited to string values (e.g., Yes for wrinkles and No for no wrinkles), Boolean values (e.g., True for wrinkles and False for no wrinkles), and/or other numeric values, including percentages and/or fractions.

Once the model is applied to each of the grid cells in the grid structure representing the produce, the computer system can compute a fraction (or percentage) of the grid cells that have wrinkles and determine whether the fraction exceeds some threshold range (708). The computer system can count how many grid cells are assigned a value of 1 or other value indicative of wrinkles. In some implementations, the computer system can determine a percent of the produce that is covered in wrinkles. If the percent of the produce covered in wrinkles exceeds the threshold range, then it can be indicative that the produce is reaching or is at the end of its duration. In some implementations, the threshold range can vary depending on the type of produce and features particular to the produce. For example, for mangoes, the threshold range can be 5%, which indicates that mangoes having more than 5% of a wrinkled surface are unsalable.

If the fraction of grid cells having wrinkles exceeds the threshold range, then the computer system can identify a shelf life and/or end of salability of the extracted produce (710). After all, the computer system can identify that the produce is no longer desirable for purchase and/or consumption by consumers. The produce may be too wrinkled and therefore is at the end of its duration. The computer system can also output wrinkle indications for the extracted produce at time=t (712). As described throughout this disclosure, the computer system can output, in a graphical depiction such as a line graph, the wrinkle indications for the produce over the period of time that the produce is imaged. Thus, a relevant stakeholder can compare how slowly the produce wrinkles over time when treated in the shelf life extension coating solution in comparison to untreated produce.

If the fraction of grid cells having identified wrinkles is less than the threshold range in 708, then the computer system can store the fraction of grid cells having wrinkles at time=t for the produce (714). The computer system can also output the stored wrinkles indication in a graphical depiction, such as a line graph. The computer system can then return to block 302 in the process 300.

FIG. 7B depicts training and runtime application of a machine learning model that determines the wrinkle quality metric of produce in FIG. 7A. The wrinkle model can be trained to identify wrinkles on any type of produce (regardless of whether the produce is treated or untreated). The wrinkle model can also be trained to identify wrinkles on a particular type of produce. For example, the wrinkle model can be trained to identify wrinkles on mangoes. Another wrinkle model can be trained to identify wrinkles on bell peppers. One or more other wrinkle models can be trained to identify wrinkles in produce that wrinkle, including but not limited to cucumbers, apples, pears, and passion fruit.

The wrinkle model can be a convolutional neural network (CNN). In some implementations, the wrinkle model can be one or more other types of neural networks and/or machine learning techniques/algorithms. The wrinkle model can leverage a wrinkling classifier to classify patches of the produce and then use the classification results to compute a coverage percentage. As described throughout this disclosure, if the coverage percentage exceeds some predetermined threshold range, then it can be determined that the produce is at the end of reaching the end of its duration. In other words, the produce may be so covered in wrinkles that the produce is no longer desirable for purchase and/or consumption by consumers.

During wrinkle model training 720, classifiers of a wrinkle model 721 can be trained to identify a patch of wrinkled produce from a patch of unwrinkled produce. The model 721 can be trained with annotated/labeled image training data, such as wrinkled produce image data 722 and unwrinkled produce imaged data 726. The image data 722 and 726 can be patches (e.g., grids) of produce. Such patches can be labeled (automatically by a computer system and/or manually by a human worker/user) as having wrinkles (image data 722) and as not having wrinkles (image data 726). The model 721 can then be trained to identify the wrinkles in the image data 722 in comparison to the absence of wrinkles in the image data 726. Thus, when the trained model 721 identifies wrinkles, such as in the image data 722, the model 721 can output a value 724, which can indicate positive identification of wrinkles, or presence of wrinkles in the particular patch of the produce. The value 724 can be a numeric value/integer/float, such as 1. The value 724, as described above, can also be a string value and/or a Boolean value. If the model 721 does not identify wrinkles in the patch of produce, such as in the image data 726, the model 721 can output a value 728, which can indicate no presence of wrinkles in the particular patch of the produce. The value 728 can be a numeric value/integer/float, such as 0. The value 728, as described above, can also be a string value and/or a Boolean value.

During runtime application 730, as described above in reference to the process 700 in FIG. 7A, a bounding box 732 representing one produce in image data of produce can be selected. Here, the produce is mangos, and the bounding box 732 is a portion of the image data depicting one whole mango. A computer system, such as the computer system 110, can generate a grid structure (block 702 in the process 700) for the bounding box 732 of the mango. Grid structure 734 can therefore overlay the bounding box 732 representing the mango. The computer system can then apply the model 721 to each grid (e.g., patch) in the grid structure 734 to classify the grids as having wrinkles or not having wrinkles (blocks 706-708 in the process 700). Resulting output 736 can include a visual representation of where wrinkles are identified on the produce and/or a wrinkle coverage percentage. For example, in the example output 736 of FIG. 7B, wrinkles were identified in 4 patches (e.g., grids). The 4 patches of wrinkles are computed to be −5% wrinkle coverage. Depending on the predetermined threshold range, 5% coverage may not be enough to signify end of the mango's duration. In other words, a mango having only 5% of its surface area covered in wrinkles may still be purchased and consumed by consumers. The mango may still taste good and/or may still be a desirable ripeness. The predetermined threshold range can vary for a particular produce. For a mango, for example, the threshold range can be 5% for one grade or class of mangoes and 20% for another grade or class of mangoes.

FIG. 8 is a flowchart of a process 800 for determining a quality features metric for produce. The process 800 can be performed as part of determining duration scoring metrics for the extracted produce in block 314 of the process 300 in FIGS. 3A-B. The process 800 is similar to the process 700 in FIG. 7A except that the process 700 is used for identifying wrinkles as a quality feature and the process 800 is used for identifying any type of quality feature. The process 800 can be performed to identify one or more different types of quality features that are indicative of quality changes, and therefore duration, of produce. One or more models and/or algorithms can be used for identifying quality features associated with a particular type of produce. One or more models and/or algorithms can be used for identifying quality features associated with different types of produce. Moreover, in some implementations, each model and/or algorithm can be used to identify a particular quality feature, regardless of the produce type. The quality features that can be identified and quantified using the process 800 can include but are not limited to wrinkles, external rot, external bruising, browning, spotting, and other external visual attributes of the produce. The quality features can also include internal attributes, including but not limited to bruising, infection, rot, firmness, dry matter, pH, brix, and/or sugar content. As described throughout this disclosure, the process 800 can be used to identify quality feature changes in both treated and untreated produce. Therefore, the changes in quality features can be compared for the treated and untreated produce to identify differences in the treated produce's duration. Such differences in duration can be attributed to the shelf life extension coating solution that the produce is treated with.

The process 800 can be performed by the computer system 110. The process 300 can also be performed by one or more other computers, computer systems, devices, cloud-based services, and/or network of computers and/or devices. For example, the process 300 can be performed by an edge computing device. For illustrative purposes, the process 300 is described from a perspective of a computer system.

Referring to the process 800, and similar to the process 700 in FIG. 7A, the computer system can retrieve machine learning trained quality feature(s) model(s) in 804. As mentioned above, a model can be trained to identify different types of quality features for a particular type of produce that is imaged. A model can also be trained to identify a particular type of quality feature for a particular type of produce. A model can be trained to identify different types of quality features for any type of produce. A model can also be trained to identify a particular type of quality feature for any type of produce. One or more other variations for models and/or algorithms are possible. In 804, the computer system can retrieve one or more models that are selected based on a type of quality feature to identify and/or a type of produce that is imaged.

Then, the computer system can apply the model to image data of the produce to identify features at time=t (806). As described in reference to FIGS. 7A-B, when the model is applied to the image, the model can output a value indicative of whether the quality feature is present (e.g., detected) or not. The value can be a numeric value/integer (such as 1 for present and 0 for not present), a string value, and/or a Boolean value. The model can be trained to identify the quality feature(s) using training image data having quality features that are labeled and annotated as such.

The computer system can determine whether the identified feature(s) exceeds a threshold range in 808. The computer system can also determine a quality feature coverage percentage (e.g., refer to FIG. 7B) that indicates how much of the produce is covered in the identified quality feature. The computer system can determine whether the coverage percentage exceeds the threshold range. As an example, if the produce is a lemon that is covered in a significant amount of browning or rot (e.g., a coverage percentage that exceeds some predetermined threshold range for browning or rot on a lemon), then the lemon may no longer be desirable for purchase and/or consumption.

Accordingly, if the identified feature(s) exceeds the threshold range, then the computer system can identify a shelf life and/or end of salability of the extracted produce (810). As mentioned above, the produce may be reaching the end or at the end of its shelf life. The produce may no longer be desirable for purchase and/or consumption. The computer system can also output feature indications for the extracted produce in 812. For example, the computer system can output what types of quality features are identified and/or how much of the quality features are identified (e.g., the coverage percentage). The computer system can also output the extracted produce with a grid structure. Grid cells having the quality features can be represented in some indicia, such as highlighting. As a result, a user who views this output at a user device can review the identified quality features and compare the identified quality features for treated and untreated produce. In some implementations, the computer system can also output a graphical depiction, such as a line graph, that indicates a coverage percentage of the treated produce and a coverage percentage of the untreated produce over time. This output can also be beneficially used by the user in order to compare effects of applying the shelf life extension coating solution to the treated produce versus the untreated produce.

If the identified feature(s) is less than the threshold range, then the computer system can store the identified feature(s) at time=t for the extracted produce (814). As described above, the computer system can output an indication of the identified feature(s). The computer system can then return to block 302 in the process 300.

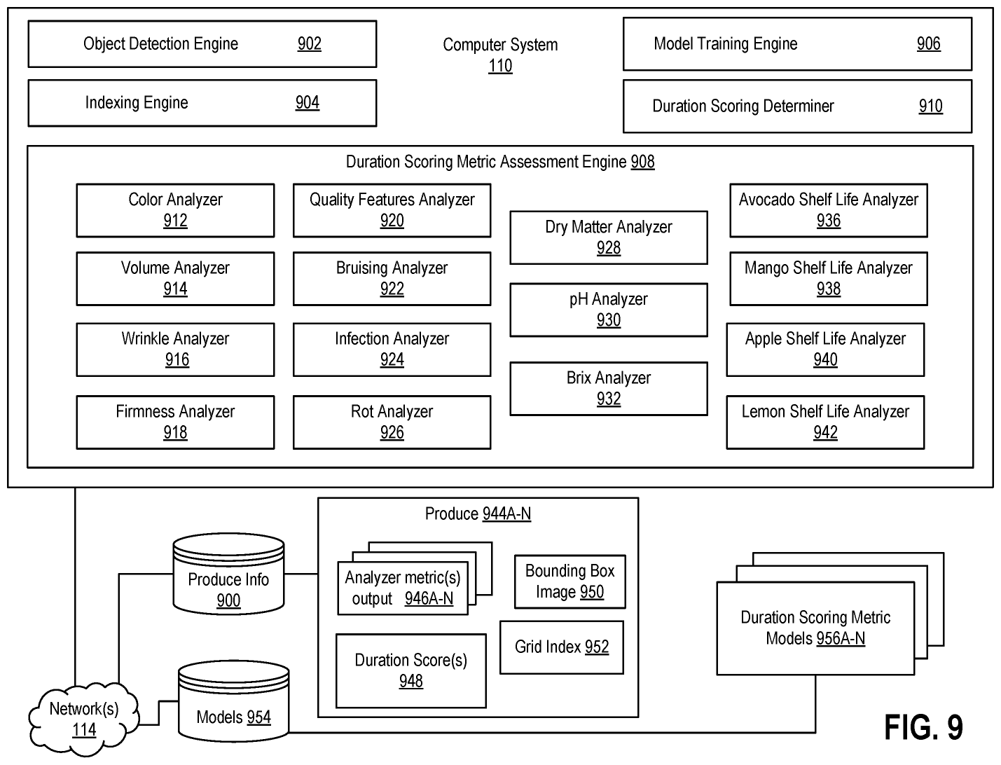

FIG. 9 is an example system diagram of components used for determining shelf life of produce using the techniques described herein. The computer system 110, produce info data store 900, and models data store 954 can be in communication (e.g., wired and/or wireless) via the network(s) 114.

The computer system 110 can include an object detection engine 902, an indexing engine 904, a model training engine 906, a duration scoring metric assessment engine 908, and a duration scoring determiner 910. Although not depicted, the computer system 110 can also include a communication interface. In some implementations, one or more of the components 902, 904, 906, 908, and/or 910 can be separate from the computer system 110 and part of one or more other computer systems, computers, servers, cloud-based services, devices, and/or networks.

The model training engine 906 can be configured to generate one or more models that can be used by the duration scoring metric assessment engine 908. The engine 906 can receive training image data of produce. The engine 906 can train models to identify features associated with the produce from the training image data, such as wrinkles and other quality features/attributes. The identified features can be annotated/labeled in the training image data. In some implementations, the trained models can be CNNs.

Generated and trained models can be stored in the models data store 954 as duration scoring metric models 956A-N. The models 956A-N can be accessed and/or retrieved by one or more analyzers of the duration scoring metric assessment engine 908 during runtime. As described throughout this disclosure, only some of the models 956A-N can be selected during runtime, based on a type of produce in the image data and/or type of feature(s) to identify and quantify in the image data. In some implementations, the models 956A-N can be continuously improved and/or updated based on runtime use of the models.

The object detection engine 902 can be configured to detect one or more produce in image data, as described throughout this disclosure (e.g., refer to FIGS. 3A-B). The engine 902 can receive the image data and perform object detection techniques to process the image data. The engine 902 can also apply one or more machine learning models that are trained to identify produce in the image data. The engine 902 can generate bounding boxes around each of the produce in the image data. For each produce 944A-N, the engine 902 can store the bounding box image of the produce 950 in the produce info data store 900. Optionally, in some implementations, the object detection engine 902 can also be configured to identify a type of produce in the image data. Thus, a produce 944A-N can include the bounding box image 950 of a treated produce. Another produce 944A-N can include the bounding box image 950 of an untreated produce.

The indexing engine 904 can be configured to apply a grid structure to the image data and index each bounding box in the structure (e.g., refer to FIGS. 3A-B). Each bounding box can encompass a produce that is represented in the image data. For each produce 944A-N, the engine 904 can retrieve the bounding box image 950 from the produce info data store 900 and assign the index value to the bounding box as grid index 952. The engine 904 can also identify each bounding box as representing treated produce or untreated produce. An indication of the produce's treatment can be stored with the grid index 952 for each produce 944A-N. Thus, each food item can be identified by the assigned index and whether the produce is treated or untreated, which can be beneficial for future retrieval of information, analysis, and processing operations.

The duration scoring metric assessment engine 908 can be configured to identify one or more features indicating quality changes of the produce in the image data (e.g., refer to FIGS. 3-8). The engine 908 can retrieve the bounding box image 950 for each food item 944A-N from the produce info data store 900. The bounding box image 950 can be used by the analyzers in determining feature changes of the produce over time, as described throughout this disclosure. The engine 908 can also retrieve one or more models 956A-N from the models data store 954 to execute during runtime. The engine 908 can select the models 956A-N based on a determination made by the object detection engine 902. For example, the engine 902 can determine that the produce identified in the image data are treated and untreated apples. The engine 902 can notify the duration scoring metric assessment engine 908 that the produce is apples. The engine 908 can then retrieve one or more models 956A-N that are associated with apples from the models data store 954. Those models can be used to analyze changes in quality of the treated and untreated produce over the period of time that the apples are imaged.

The duration scoring metric assessment engine 908 can include a plurality of analyzers, where each analyzer can be configured to identify a different quality feature in the produce and/or different types of quality features in one or more types of produce. Each model 956A-N can also be executed by a different analyzer. In some implementations, one or more of the models 956A-N can also be executed by one or more analyzers. Although some example analyzers are depicted in FIG. 9, additional, fewer, and/or different analyzers may be included in the engine 908. The engine 908 can therefore include one or more additional or fewer analyzers. Each of the analyzers can receive, for each food item 944A-N, the bounding box image 950 of that produce.

By way of example, the duration scoring metric assessment engine 908 can include a color analyzer 912, a volume analyzer 914, a wrinkle analyzer 916, a firmness analyzer 918, a quality features analyzer 920, a bruising analyzer 922, an infection analyzer 924, a rot analyzer 926, a dry matter analyzer 928, a pH analyzer 930, a brix analyzer 932, a sugar content analyzer 934, an avocado shelf life analyzer 936, a mango shelf life analyzer 938, an apple shelf life analyzer 940, and a lemon shelf life analyzer 942. Any one or more of the analyzers 912, 914, 916, 918, 920, 922, 924, 926, 928, 930, 932, 936, 938, 940, and 942 can retrieve and apply duration scoring metric models 956A-N. Outputs from any one or more of the analyzers can be stored, for each produce 944A-N as analyzer metric(s) output 946A-N in the produce info data store 900. Moreover, as described throughout this disclosure, the duration scoring metric assessment engine 908 can implement only one analyzer to determine quality changes of the produce over time. In some implementations, the duration scoring metric assessment engine 908 can implement multiple analyzers to determine overall quality changes of the produce over time.

Referring to the exemplary analyzers depicted in FIG. 9, the color analyzer 912 can be configured to analyze the bounding box image 950 to determine the color of the produce at each time interval that the produce is imaged relative to a reference color (e.g., the statistical measure color value representing the color of the produce when the produce is first imaged, at t=1). The color analyzer 912 can be applied to any type of produce that is imaged. In some implementations, the color analyzer 912 can implement models and/or algorithms that are specific to a type of produce that is imaged. For example, a model can be executed that is trained to assess color changes in lemons while another model can be trained to assess color changes in Granny Smith apples. Refer to FIGS. 4-5 for further discussion about identifying, quantifying, and outputting color changes of the imaged produce.

The volume analyzer 914 can be configured to analyze the bounding box image 950 to determine a percent shrink in volume of the produce at each time interval relative to a reference volume (e.g., the volume of the produce when the produce is first imaged, at t=1). The volume analyzer 914 can be used to analyze volume in different types of produce. Refer to FIG. 6 for further discussion on analyzing, quantifying, and outputting changes in volume for the produce that is imaged.

The wrinkle analyzer 916 can be configured to identify and quantify wrinkles in the bounding box image 950 to determine a wrinkle coverage percentage of the produce at each time interval. The wrinkle analyzer 916 can be used to analyze wrinkles in different types of produce. The analyzer 916 can, for example, implement a model for analyzing wrinkles in a particular type of produce, such as mangos. Another model can be implemented by the analyzer 916 to identify wrinkles in another type of produce, such as bell peppers, cucumbers, apples, passion fruit, or other types of produce that wrinkles. Refer to FIGS. 7A-B for further discussion about analyzing, quantifying, and outputting changes in wrinkles for the produce that is imaged.

The firmness analyzer 918 can be configured to identify and quantify firmness of the produce in the bounding box image 950 to determine a change in firmness of the produce at each time interval relative to a reference volume. The firmness analyzer 918 can use one or more models and/or algorithms to determine firmness of the produce. Firmness can be identified from hyperspectral image data. Firmness can also be determined from a combination of image data and destructive measurements taken of the produce. The firmness analyzer 918 can generate output data such as a score indicating a level of firmness. The output data can be a numeric value within a range, such as 0 to 1. A value of 0 can indicate that the depicted produce is hard and inedible, whereas any value above 0 and less than 1 can provide an indication of firmness that is not hard. For example, output values closer to 1 can indicate that the produce is softer, less firm, and/or approaching a maximum softness that the produce should be (e.g., nearing the produce's end of duration). In some implementations, and depending on a type of the produce, the maximum softness can indicate that the produce is of good quality and is ready to be consumed by consumers. In some implementations, the maximum softness can indicate that the produce is of poor quality and is no longer a desired firmness to be purchased and/or consumed by consumers.

The quality features analyzer 920 can be configured to identify and quantify one or more quality features in the bounding box image 950 to determine what and how many quality features are present on the produce at each time interval. The analyzer 920 can be used to analyze quality features in different types of produce. Refer to FIG. 8 for further discussion about analyzing, quantifying, and outputting changes in quality features for the produce that is imaged.

The bruising analyzer 922, like the quality feature analyzer 920, can be configured to identify and quantify internal and/or external bruising that appears in the bounding box image 950 of the produce at each time interval relative to a reference quantity of bruising (when the produce was first imaged, at t=1).

The infection analyzer 924, like the quality feature analyzer 920, can be configured to identify and quantify internal and/or external infection that appears in the bounding box image 950 of the produce at each time interval relative to a reference quantity of infection (when the produce was first imaged, at t=1).

The rot analyzer 926, like the quality feature analyzer 920, can be configured to identify and quantify internal and/or external rot that appears in the bounding box image 950 of the produce at each time interval relative to a reference quantity of rot (when the produce was first imaged, at t=1).

The dry matter analyzer 928, like the quality feature analyzer 920, can be configured to identify and quantify dry matter in the bounding box image 950 of the produce at each time interval relative to a reference quantity of dry matter (when the produce was first imaged, at t=1). The dry matter analyzer 928 can be used to assess dry matter in avocados.

The pH analyzer 930, like the quality feature analyzer 920, can be configured to identify and quantify acid level from hyperspectral data, which may be derived from the bounding box image 950 of the produce at each time interval. The acid level can be compared to a reference quantity of pH (when the produce was first imaged, at t=1) to determine a duration of the produce.

The brix analyzer 932, like the quality feature analyzer 920, can be configured to identify and quantify sugar content of the produce from hyperspectral data, which may be derived from the bounding box image 950 of the produce at each time interval. The sugar content at each time interval can then be compared to a reference sugar content (when the produce was first imaged, at t=1) to determine a duration of the produce. Thus, the analyzer 932 can be configured to determine sweetness and/or tartness of the produce, which can be an indication of whether and when the produce is desirable for purchase and/or consumption by consumers.

The avocado shelf life analyzer 936 can be configured to determine duration (e.g., ripeness, shelf life, edibility, salability) of avocados using one or more of the techniques described throughout this disclosure. For example, the avocado shelf life analyzer 936 can identify and quantify color and volume changes of the avocados over the period of time that the avocados are imaged. The avocado shelf life analyzer 936 can then determine the durations for both treated and untreated avocados based on color changes, volume changes, or a combination of both. The avocado shelf life analyzer 936 can also determine the durations of treated and untreated produce using one or more additional techniques, such as analysis and quantification of wrinkles, firmness, quality features, bruising, infection rot, and/or dry matter. Moreover, the avocado shelf life analyzer 936 can also be configured to generate output indicating the durations of the treated and untreated produce. As described throughout this disclosure, the analyzer 936 can generate graphical depictions, such as line graphs or histograms, depicting the change in color and/or volume over time for both the treated and untreated produce. This output can then be used by the computer system 110 and/or a relevant stakeholder at a user device to determine whether any modifications should be made to the shelf life extension coating solution that is applied to the treated produce.

The mango shelf life analyzer 938 can be configured to determine duration (e.g., ripeness, shelf life, edibility, salability) of mangos using one or more of the techniques described throughout this disclosure. For example, the mango shelf life analyzer 938 can identify and quantify color, volume, and/or wrinkle changes of the mangos over the period of time that the mangos are imaged. The mango shelf life analyzer 938 can then determine the durations for both treated and untreated mangos based on color changes, volume changes, wrinkles, or a combination of multiple of these quality attributes. The mango shelf life analyzer 938 can also determine the durations of treated and untreated produce using one or more additional techniques, such as analysis and quantification of firmness, quality features, bruising, infection rot, pH, and/or brix. Moreover, the mango shelf life analyzer 938 can also be configured to generate output indicating the durations of the treated and untreated produce. As described throughout this disclosure, the analyzer 938 can generate graphical depictions, such as line graphs or histograms, depicting the change in color, volume, and/or wrinkle coverage over time for both the treated and untreated produce. This output can then be used by the computer system 110 and/or a relevant stakeholder at the user device to determine whether any modifications should be made to the shelf life extension coating solution that is applied to the treated produce.

The apple shelf life analyzer 940 can be configured to determine duration (e.g., ripeness, shelf life, edibility, salability) of apples using one or more of the techniques described throughout this disclosure. In some implementations, the analyzer 940 can determine duration of different types of apples. In other implementations, the analyzer 940 can be configured to determine duration of a particular type of apple. For example, one apple shelf life analyzer can determine duration of Granny Smith apples and another apple shelf life analyzer can determine duration of Honey Crisp apples. The analyzers can use different threshold ranges and/or levels based on the type of apple. For example, a statistical measure color value can be a shade of green for Granny Smith apples and a mix of red and yellow for Honey Crisp apples. Moreover, the Granny Smith apples and the Honey Crisp apples can have different levels of sweetness and/or tartness, where the tartness of a Granny Smith apple may be desired to consumers but a similar level of tartness for Honey Crisps may not be as desirable to consumers.

The apple shelf life analyzer 940 can identify and quantify one or more quality attributes that changed over the period of time that the apples are imaged. The apple shelf life analyzer 940 can then determine the durations for both treated and untreated apples based on one or more quality attributes that are assessed during the period of time. For example, the apple shelf life analyzer 940 can determine the durations of treated and untreated produce based on analysis and quantification of changes in any one or more of color, volume, firmness, quality features, bruising, infection rot, pH, and/or sugar content. Moreover, the apple shelf life analyzer 940 can also be configured to generate output indicating the durations of the treated and untreated produce. As described throughout this disclosure, the analyzer 940 can generate graphical depictions, such as line graphs or histograms, depicting the change in quality attribute(s) over time for both the treated and untreated produce. This output can then be used by the computer system 110 and/or a relevant stakeholder at the user device to determine whether any modifications should be made to the shelf life extension coating solution that is applied to the treated produce.

The lemon shelf life analyzer 942 can be configured to determine duration (e.g., ripeness, shelf life, edibility, salability) of lemons using one or more of the techniques described throughout this disclosure. In some implementations, the analyzer 942 can also be used to determine duration of limes or other similar citrus fruits. The lemon shelf life analyzer 942 can identify and quantify color and volume changes of the lemons over the period of time that the lemons are imaged. The lemon shelf life analyzer 942 can then determine the durations for both treated and untreated lemons based on color changes, volume changes, or a combination of both. The lemon shelf life analyzer 942 can also determine the durations of treated and untreated produce using one or more additional techniques, such as analysis and quantification of wrinkles, firmness, quality features, bruising, infection rot, dry matter, pH, and/or sugar content. Moreover, the lemon shelf life analyzer 942 can also be configured to generate output indicating the durations of the treated and untreated produce. As described throughout this disclosure, the analyzer 942 can generate graphical depictions, such as line graphs or histograms, depicting the change in color and/or volume over time for both the treated and untreated produce. This output can then be used by the computer system 110 and/or a relevant stakeholder at the user device to determine whether any modifications should be made to the shelf life extension coating solution that is applied to the treated produce.

The duration scoring determiner 910 can be configured to determine an overall duration score for the produce that is imaged and analyzed using the techniques described herein. For example, the duration scoring determiner 910 can determine whether the changes in quality attributes are within a threshold range and/or exceed some threshold level for the particular type of produce. The duration scoring determiner 910 can retrieve and apply one or more duration scoring metric models 956A-N from the models data store 954 to determine the duration scores for the treated and untreated produce that is imaged. The duration scoring determiner 910 can receive duration scoring metrics from the duration scoring metric assessment engine 908 and use those metrics to determine the overall duration for the produce. In some implementations, the duration scoring determiner 910 can generate the output described throughout this disclosure, such as the graphical depictions (e.g., line graphs) depicting the changes in one or more quality attributes for treated and untreated produce. The duration scores, as described throughout this disclosure, can indicate a level of ripeness, length of ripeness, remaining shelf life, length of shelf life, edibility, and/or salability of the produce. The duration scores generated by the duration scoring determiner 910 can be stored in the produce info data store 900 for each produce 944A-N as duration score(s) 948. The duration score(s) 948 can be retrieved and outputted at a later time at the user device for analysis and review by relevant stakeholders in the supply chain.

As described throughout, the aforementioned example analyzers do not function to limit scope of the present disclosure. Instead, any type of analyzer can be used by the duration scoring metric assessment engine 908. Likewise, characterizations of inputs and outputs for each of the example analyzers should not be viewed as limiting. The analyzers can be configured and/or trained to generate other types of output data and receive other types of input data.

FIG. 10 is an example environment for capturing time lapse image data of produce. Components of an imaging environment 1000 can be in communication with the computer system 110, the user device 112, and/or the produce info data store 900 via the network(s) 114. The components of the imaging environment 1000, described further below, can be remote from one or more of the computer system 110, the user device 112, and/or the data store 900. In some implementations, the computer system 110 can be part of the imaging environment 1000. For example, the computer system 110 can be an edge computing device that is configured to, in real-time, identify and quantify changes in quality attributes of produce that is being imaged in the imaging environment 1000. This configuration can be advantageous to avoid clogging network bandwidth and/or to use computing resources more efficiently. In such an implementation, the computer system 110 can be attached or otherwise part of a camera 1004 in the imaging environment 1000. The imaging environment 1000 can further include a power source that can be used to provide power to components of the imaging environment 1000, including the computer system 110, the camera 1004, and other components, such as one or more fans and/or one or more light sources.

In some implementations, the user device 112 can be part of the computer system 110 and/or the imaging environment 1000. The user device 112 can include a display screen and one or more input devices, such as a mouse, keyboard, microphone, and/or touch screen. The user device 112 may also be powered by the same or another power source of the imaging environment 1000. During operation, the computer system 110 can schedule when images are captured by the camera 1004. The computer system 110 can send a notification to the camera 1004 that triggers the camera 1004 to capture one or more images of the produce 1010A-N. For example, every 5 hours for 30 days, the computer system 110 can transmit a notification to the camera 1004 that prompts the camera 1004 to capture one or more images of the produce 1010A-N. Images captured by the camera 1004 can then be transmitted to the computer system 110 for processing and outputted at the user device 112. For example, the computer system 110 can receive images of produce 1010A-N, analyze the images to determine quality attributes of the produce 1010A-N (e.g., duration scoring metrics), and determine a duration score for each of the produce 1010A-N and/or a batch of the produce 1010A-N. The determined duration score(s) and/or the quality attributes can be transmitted to and presented at the display screen of the user device 112. The images can also be transmitted to and presented/outputted at the user device 112. A relevant stakeholder can then review the outputted information and determine whether any modifications can and/or should be made to the shelf life extension coating solution that is applied to one or more of the produce 1010A-N.

The imaging environment 1000 can include a fan 1002, a camera 1004, rigs 1006A-N, and at least one light source 1008A-N. The imaging environment 1000 can be a box having walls on all sides as well as a top and bottom. Produce 1010A-N can be positioned on the bottom of the imaging environment 1000, such as on a pallet or flat. The produce 1010A-N can remain in such positions for an entire period of time that the produce 1010A-N is being imaged by the camera 1004. As a result, the camera 1004 can capture images of the produce 1010A-N at constant time intervals during the period of time from a constant angle and lighting. This can be beneficial to increase accuracy of comparing quality attribute changes in the produce 1010A-N over time.

The fan 1002 can be configured to circulate air inside of the imaging environment 1000. The fan 1002 can be attached to the rig 1006N that can be positioned at a top ceiling of the imaging environment 1000. The fan 1002 can also be positioned in other locations in the imaging environment 1000. In some implementations, the imaging environment 1000 can have multiple fans.

The camera 1004 can be attached to the rig 1006N. The camera 1004 can be centered and positioned at the top ceiling of the imaging environment 1000. Therefore, the camera 1004 can have a field of view that includes all of the produce 1010A-N from a constant angle. In some implementations, a motor can be used to move produce on a motorized tray near, below, or otherwise proximate a hyperspectral camera such that the hyperspectral camera can capture images line by line of the produce 1010A-N (e.g., line of pixels after line of pixels to form a full matrix that is a hyperspectral image of the produce 1010A-N). The camera 1004, as described herein, can be configured to capture images of the produce 1010A-N at constant time intervals throughout the period of time that the produce 1010A-N is being imaged. For example, the camera 1004 can capture multiple images of the produce 1010A-N 5 times a day for 30 days.

As described herein, the camera 1004 can generate image data that represents attributes of produce 1010A-N. In some implementations, the camera 1004 can include one or more hyperspectral sensors configured to capture hyperspectral data that represents features of the produce 1010A-N. In such implementations, each pixel of the hyperspectral image can correspond to a visible light spectrum, which can be part of a near-infrared (NIR) range for the hyperspectral data. As a result, one hyperspectral camera can be used to capture data and extract RGB images (and/or video) from the data without the need to capture additional data with another RGB camera. In some implementations, the camera 1004 can be a low-resolution digital camera (e.g., 5M or less), a high-resolution digital camera (e.g., 5MP or more), or any other type of sensor that can capture image data.

In some implementations, the imaging environment 1000 can include multiple sensors or cameras positioned at multiple angles relative to the produce 1010A-N. For example, a first camera and at least one additional second camera can each capture image data of the produce 1010A-N from different perspective angles. In such configurations, the one or more additional cameras can be used to generate image data based on different or additional wavelengths of light than the wavelengths of light captured by the first camera.

Each particular camera of the one or more cameras can be configured to detect the different or additional wavelengths of light in a number of different ways. For example, in some implementations, different sensors can be used in different cameras in order to detect different or additional wavelengths of light. Alternatively, or in addition, each of the one or more cameras can be positioned at a different heights, at different angles, or the like relative to each other in an effort to capture different wavelengths of light. In some implementations, one or more cameras can be positioned, at least in part, to capture portions of the produce 1010A-N that may be obscured from a view of the first camera.

The light sources 1008A-N can be used to illuminate the produce 1010A-N so that the camera 1004 can capture clearly image data of the produce. The light sources 1008A-N can be attached to rigs 1006A and 1006B positioned at the top/ceiling of the imaging environment 1000. The light sources 1008A-N can be arranged in such a way to provide consistent and uniform lighting on the produce 1010A-N. This can be beneficial since the imaging environment 1000 can be a closed setting that does not permit additional ambient lighting to filter in and cast shadows or uneven lighting conditions on the produce 1010A-N to be imaged.

The light sources 1008A-N can include one or more light sources that each produce a same or different electromagnetic radiation. In some implementations, the light sources 1008A-N can be positioned in one or more locations in a vicinity of the camera 1004 in order to illuminate the produce 1010A-N before and/or during capture of the image data. In some implementations, one or more of the light sources 1008A-N can be selected based on a frequency of the electromagnetic radiation output. For example, in some implementations, one or more of the light sources 1008A-N can be halogen light source(s). Alternatively, or in addition, the one or more light sources 1008A-N can be a diode or series of diodes of broadband light-emitting diodes (LEDs) that can be used to provide light across the visible wavelength spectrum, near infrared wavelength spectrum, electromagnetic spectrum, or any other spectrum of light, such as a UV spectrum. In general, any light source can be used to provide any type of light for the camera 1004.

In some implementations, the one or more of the light sources 1008A-N, or a control unit of the one or more light sources 1008A-N, can be communicably connected to the camera 1004, or a control unit of the camera 1004. For example, the camera 1004, or the control unit of the camera 1004, send a signal to the one or more light sources 1008A-N, or the control unit of the one or more light sources 1008A-N, that cause the light sources 1008A-N to illuminate the produce 1010A-N with one or more specific wavelengths of light at a specific power and/or at a specific moment in time. In some implementations, the specific moment in time can be a predetermined amount of time before, or during, capturing of the image data.

The image data can be made up of a plurality of images, where each of the images corresponds to one or more of the produce 1010A-N in the imaging environment 1000. The image data can also include a portion of a background surrounding the produce 1010A-N, such as a bottom/ground/floor of the imaging environment 1000. As described throughout, the computer system 110 can process the image data and extract a portion of the image data that depicts one or more of the produce 1010A-N. The extracted portion of the image data can depict all the produce 1010A-N that is imaged. In some implementations, the extracted portion of the image data can depict one of the produce 1010A-N. The computer system 110 can therefore generate extracted portions (e.g., bounding boxes) for each of the produce 1010A-N that is imaged.

The imaging environment 1000 can contain any number of produce 1010A-N for imaging. The same produce 1010A-N that is put in the imaging environment 1000 on a first day of imaging can remain within the imaging environment 1000 until the entire period of time of imaging is complete (e.g., 30 days for some produce, such as avocados). The imaging environment 1000 can be sized to fit different types of produce and/or different quantities of produce. As an illustrative example, the imaging environment 1000 can be sized to fit 6 avocados, where 3 of the avocados are treated (e.g., coated with the shelf life extension coating solution) and 3 of the avocados are untreated (e.g., not coated in any products or solutions). The imaging environment 1000 can also be sized to fit 25 avocados, in 5 rows of 5. The same imaging environment 1000 can also be sized and used to image 4 apples, where 2 are treated and 2 are untreated. The same imaging environment 1000 can also be used to image 8 lemons, where 4 are treated and the other 4 are untreated. As described above, the imaging environment 1000 can fit any number of the produce 1010A-N that is desired to be imaged. The produce 1010A-N can be arranged in the imaging environment 1000 in a grid configuration. In some implementations, the produce 1010A-N can merely be placed inside the imaging environment 1000 in no particular configuration.

The computer system 110 can utilize one or more machine learning algorithms, techniques, and/or models that are trained to detect produce in the image data and extract the detected produce. Such algorithms, techniques, and/or models can also be trained to identify the type of produce that is detected in the image data. As an illustrative example, the produce 1010A-N can be avocados. The computer system 110 can utilize one or more models that are trained on a plurality of images of avocados to determine, from the image data, whether or not one or more avocados are depicted and what regions of the image data include the avocados. The one or more models can also be trained to produce output data in the form of an annotated image of one or more of the produce 1010A-N. In producing the annotated image, the computer system 110 can annotate or otherwise index each of the identified avocados in the image data. As described throughout this disclosure, quality attributes (e.g., duration scoring metrics) can be determined for each of the annotated/indexed avocados in the image data. As described throughout this disclosure, the imaging environment 1000 can be used to assess quality and duration of different types of produce, including but not limited to citrus fruits, mangos, apples, berries, stone fruits, tomatoes, meat, and/or vegetables.

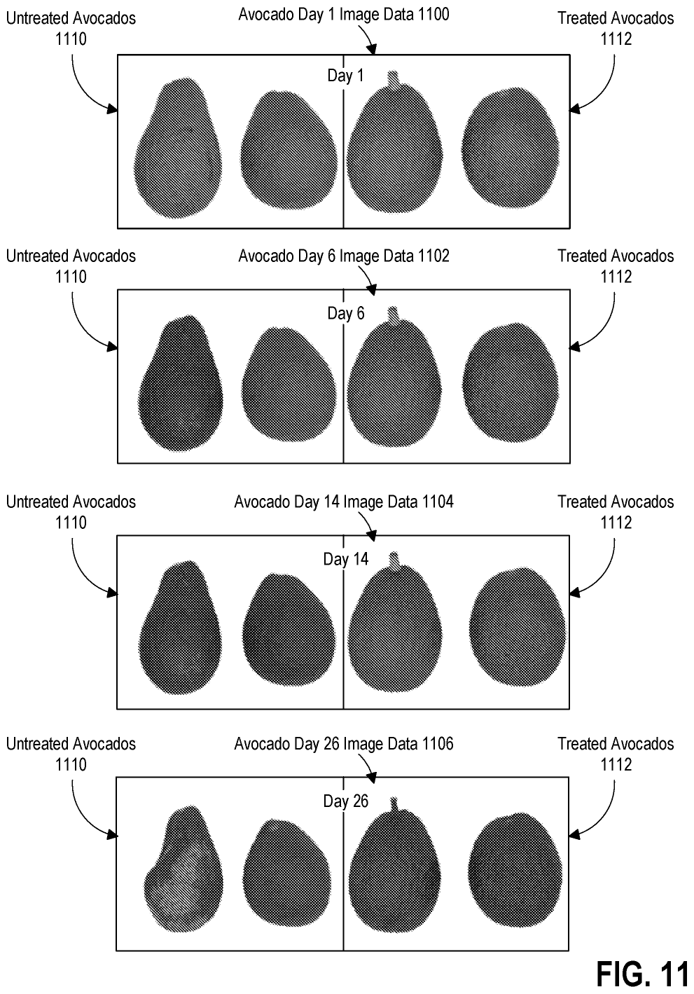

FIG. 11 depicts example time lapse image data comparing treated and untreated produce. The image data of FIG. 11 depicts untreated avocados 1110 and treated avocados 1112. As described herein, the treated avocados 1112 can be coated in shelf life extension coating solution. Image data 1100 depicts the untreated 1110 and treated 1112 avocados on day 1 of imaging. Image data 1102 depicts the untreated 1110 and treated 1112 avocados on day 6 of imaging. Image data 1104 depicts the untreated 1110 and treated 1112 avocados on day 14 of imaging. Image data 1106 depicts the untreated 1110 and treated 1112 avocados on day 26 of imaging.

As shown in the image data 1100, 1102, 1104, and 1106, the untreated avocados 1110 are the first to shrink in size and darken (e.g., become less firm and/or more ripe). In other words, over the 26 days of imaging, the untreated avocados 1110 have a shorter duration (e.g., shorter shelf life, edibility, salability) than the treated avocados 1112. The first untreated avocado 1110 was first to darken on day 6, in the image data 1102. The two untreated avocados 1112 did not darken until day 26, as shown in the image data 1106. The quality attributes depicted in the image data 1100, 1102, 1104, and 1106 can be identified and quantified by a computer system (e.g., the computer system 110) to determine duration of both the untreated avocados 1110 and the treated avocados 1112.

FIG. 12 is an example shelf life analysis 1200 of avocados, using the disclosed techniques. The untreated avocados 1110 and treated avocados 1112 can be imaged using the techniques described herein. The shelf life analysis 1200 can be performed by a computer system, such as the computer system 110 described throughout this disclosure.

As part of the shelf life analysis 1200, the computer system can identify locations of the untreated avocados 1110 and the treated avocados 1112 (1202). As described in reference to the process 300 in FIGS. 3A-B, the computer system can determine bounding boxes around each of the avocados 1110 and 1112. The computer system can also determine a grid structure and assign grid indexes to each bounding box of the avocados 1110 and 1112. For example, the first untreated avocado 1110 can be assigned a grid index of 0. The second untreated avocado 1112 can be assigned a grid index of 1. The first treated avocado 1112 can be assigned a grid index of 2. The second treated avocado 1112 can be assigned a grid index of 3.

The computer system can also extract pixels for each of the avocados 1110 and 1112 at each time point when the avocados 1110 and 1112 are imaged (1204). Refer to discussion in 310 of the process 300 in FIG. 3A for additional discussion.

The computer system can then compute quality features (1206) for the avocados 1110 and 1112. The computer system can identify changes in color for the avocados 1110 and 1112, based on analysis of the extracted pixels from 1204. The changes in color over time can be compared to a statistical measure color value that is determined at the first time point of imaging (e.g., when the avocados 1110 and 1112 were first imaged). The statistical measure color value can be an average color value for all of the avocados 1110 and 1112 on the first day of imaging. The computer system can compare pixels of the avocados 1110 and 1112 to the statistical measure color value on a pixel by pixel basis. For example, using the pixel by pixel basis, a distance of each pixel from the statistical measure color value determined at a first time of imaging can be computed. The distance can be used to generate a matrix of distances (e.g., one distance per pixel). The computer system can then compute a mean, median, or other statistical measure of the distance distribution, which can be a duration metric of which threshold ranges can then be applied to, as described above. One or more other techniques can be used as described above.

Changes in color can be graphed over time in a line graph 1210. The computer system can determine the line graph 1210 for the group of untreated avocados 1110 and the group of treated avocados 1112. Thus, one of the line graphs 1210 can depict average changes in color over time for the untreated avocados 1110 and another of the line graphs 1210 can depict average changes in color over time for the treated avocados 1112. The computer system can also generate a line graph that depicts both the average changes in color over time for the untreated avocados 1110 and the average changes in color over time for the treated avocados 1112.

The computer system can also identify changes in volume over time in 1206 for the avocados 1110 and 1112, based on analysis of the extracted pixels from 1204. The changes in volume over time can be compared to an average original volume for the avocados 1110 and 1112 that is determined at the first time point of imaging (e.g., when the avocados 1110 and 1112 were first imaged). The average original volume can be an average volume value for all of the avocados 1110 and 1112 on the first day of imaging. Changes in volume can be graphed over time in a line graph 1212. The computer system can determine the line graph 1212 for the group of untreated avocados 1110 and the group of treated avocados 1112. Thus, one of the line graphs 1212 can depict average changes in volume over time for the untreated avocados 1110 and another of the line graphs 1210 can depict average changes in volume over time for the treated avocados 1112. The computer system can also generate a line graph that depicts both the average changes in volume over time for the untreated avocados 1110 and the average changes in volume over time for the treated avocados 1112.

The computer system can then use a threshold to determine shelf life of the avocados 1110 and 1112 (1208). As described herein, the shelf life can be the duration score. The computer system can also determine an end of shelf life, edibility, ripeness, and/or salability of the avocados 1110 and 1112. The end of life threshold 1216 can also be included in shelf life graph 1214. In some implementations, the shelf life graph 1214 can be a combination of the changes in color over time and the changes in volume over time from 1206. The end of life threshold 1216 can be used for both the untreated avocados 1110 and the treated avocados 1112. Thus, the end of life threshold 1216 can be included in the line graph 1210 depicting color changes for either of the avocados 1110 and 1112. The end of life threshold 1216 can also be included in the line graph 1212 depicting volume changes for either of the avocados 1110 and 1112.

As shown in 1208, shelf life graph 1214 depicts changes in volume over time for either the untreated avocados 1110 or the treated avocados 1112. Shelf life 1218 is identified as the time point at which the line of the graph 1214 intersects the end of life threshold 1216. As described further below, the shelf life 1218 can be later in time for the treated avocados 1112 in comparison to the shelf life of the untreated avocados 1110.

As described throughout this disclosure, the computer system can determine the shelf life 1218 using just the color quality attributes or just the volume quality attributes. In some implementations, the computer system can determine the shelf life 1218 based on a combination of the color quality attributes and the volume quality attributes. Moreover, in some implementations, the computer system can determine the shelf life 1218 based on a combination of one or more other quality attributes, such as wrinkles, firmness, rot, infection, and/or other attributes that are identified and quantified using the techniques described herein.

FIG. 13 is an example statistical measure color determination 1300 for avocados using the process of FIG. 5. The statistical measure color determination 1300 can be performed by a computer system, such as the computer system 110. The computer system can receive the image data 1100 of the avocados 1110 and 1112 at the first time point when the avocados 1110 and 1112 are imaged using the techniques described herein. Here, the computer system receives the image data 1100 of the avocados 1110 and 1112 on day 1. For each of the avocados 1110 and 1112, the computer system can extract their corresponding pixels (1302). The computer system can therefore generate a mask 1304 of the avocados 1110 and 1112.

The computer system can determine a mean or average of all the color pixels of all the avocados 1110 and 1112 in the mask 1304 (1306). The mask 1304 can be used to extract RGB data of the avocados 1110 and 1112 by extracting all RGB values of pixels from RGB image data for which the mask 1304 has a value of True or 1 (e.g., yellow color). Thus, the computer system can determine and output a statistical measure color value 1308. The statistical measure color value 1308 can demonstrate the average or mean color value for all the avocados 1110 and 1112 when they were first imaged on day 1. The computer system can then compare detected colors of the avocados 1110 and 1112 in the image data at each of the subsequent time points of imaging. Comparing detected colors of the avocados 1110 and 1112 to the statistical measure color value 1308 can include computing distances (e.g., Euclidean distance) between all pixels representing each of the avocados 1110 and 1112 at each time point and the statistical measure color value 1308. The computed distances can be graphed over time to show how the color of the avocados 1110 and 1112 changes over time.

FIG. 14 is an example color analysis 1400 over time of avocados 1110 and 1112 using the processes of FIGS. 3-5. The color analysis 1400 can be used to quantify the changes in color that are visible in the image data 1100 of the avocados 1110 and 1112 on day 1 and in the image data 1104 of the avocados 1110 and 1112 on day 14. The color analysis 1400 can also be performed to identify changes in color that are visible in image data of the avocados 1110 and 1112 throughout an entire period of imaging, such as 30 days.

As shown in FIG. 14, each of the avocados 1110 and 1112 can be indexed. Avocados 0 and 1 are both untreated avocados 1110. Avocados 2 and 3 are both treated avocados 1112. The colors identified for the avocados 1110 and 1112 at each of the time points that they are imaged can be compared to the statistical measure color value 1308. The computer system can then generate a color over time graph 1402, which depicts the change in color over time for each of the avocados 1110 and 1112: avocados 0, 1, 2, and 3.

As depicted in the graph 1402, by approximately day 5, avocado 0 (an untreated avocado 1110) has reached a significant distance in color. The avocado 0 started with a color distance of 5 at the first time point of imaging (0 days). By day 5, the avocado 0 reached a color distance of 25, while the avocados 1, 2, and 3 remained around or below a color distance of 5. By approximately day 6, avocado 1 (an untreated avocado 1110) has reached a significant distance in color. The avocado 1 started with a color distance of approximately 1 at the first time point of imaging. By day 6, the avocado 1 reached a color distance of 25, while the avocados 2 and 3 remained around or below a color distance of 5. By approximately day 20, the avocado 3 reaches a color distance of approximately 25. By approximately day 23, the avocado 2 reaches a color distance of approximately 25. Thus, in comparison to the untreated avocados 1110, avocados 2 and 3, both treated avocados 1112, reach a significant color distance approximately 15 days later. This can be attributed to application of the shelf life extension coating solution to the avocados 1112. Thus, the shelf life extension coating solution can increase a shelf life, edibility, and/or salability of the avocados 1112 (e.g., duration score), as demonstrated in the graph 1402.

FIG. 15 is an example volume analysis 1500 over time of avocados using the process of FIG. 6. As described herein, a computer system, such as the computer system 110, can count a number of pixels in the image data that represent an avocado (1502). As shown in FIG. 15, the computer system counts 244,000 pixels. The computer system can designate the pixel count as the area of the avocado and then solve for the radius (1504). Using the radius, the computer system can solve for the volume of the avocado (1506). Here, the computer system can use a formula for the volume of a sphere since the avocado is a relatively spherical/round object. The formula for the volume of a sphere can also be used for other produce, such as apples, lemons, limes, and other produce that are relatively round.

The computer system can also plot changes in volume over time in a line graph 1508. The computer system can plot and output the changes in volume over time for each avocado that is imaged. In some implementations, the computer system can determine an average change in volume over time for treated avocados and an average change in volume over time for untreated avocados. The computer system can then output these average changes in volume over time in a same line graph and/or separate line graphs.

The example line graph 1508 depicts changes in volume over time for an avocado that is labeled as avocado 1. Avocado 1 can be an untreated avocado, as shown in FIGS. 11-14. On day 0, which can be a first day of imaging, avocado 1 is at 100% of its volume. In other words, a baseline volume for the avocado 1 can be the volume that is measured on the first day of imaging. Volumes that are measured on subsequent days can be compared to the baseline volume to determine how much the volume has changed since the first day of imaging. The greater change in volume, the more the avocado shrinks. The greater change in volume, the shorter the duration of the avocado.

Here, as shown in the line graph 1508, the avocado 1 dropped to approximately 93% of its original volume (e.g., the baseline volume of day 1) by day 5 (in some implementations, produce can drop by one or more other percentages of its original volume over one or more other periods of time since day 1). The avocado 1 dropped to approximately 88% of its original volume by day 10. By day 23, the avocado 1 was down to approximately 75% of its original volume. As described herein, applying the shelf life extension coating solution to the avocado 1 can be beneficial to slow down how much and/or how quickly the volume of the avocado changes over time. As a result, the duration of the treated avocado can be increased or otherwise improved, which makes the avocado more desirable for purchase and consumption by consumers.

FIG. 16 is an example shelf life analysis 1600 of avocados based on volume, using the disclosed techniques. As shown in FIG. 16, the techniques described herein can be used to quantify the change in volume that is depicted from day 1 in the image data 1100 of the avocados to day 26 (or later) in the image data 1106. Quantifying the change in volume for the untreated avocados 1110 in comparison to the change in volume for the treated avocados 1112 is beneficial to demonstrate that treating avocados 2 and 3 in the shelf life extension coating solution causes the treated avocados 1112 to have 3.2+/−0.6 times longer duration (e.g., shelf life, ripeness, edibility, and/or salability) than the untreated avocados 1110.

Shelf life graph 1602 depicts shelf life of untreated avocados 1110 and treated avocados 1112 when each reaches 10% volume shrink. For example, avocado 0 (an untreated avocado 1110) experiences 10% volume shrink when the avocado 0 reaches 8-9 days. The 8-9 day range can be identified as the shelf life of the avocado 0. Avocado 1 (an untreated avocado 1110) experiences 10% volume shrink when the avocado 1 reaches approximately 10 days. On the other hand, avocado 2 (a treated avocado 1112) experiences 10% volume shrink after almost 30 days and avocado 3 (a treated avocado 1112) experiences 10% volume shrink after approximately 25 days. Avocados 2 and 3 experience longer shelf lives (approximately 30 and 25 days, respectively), because they are treated with the shelf life extension coating solution. Avocados 2 and 3 experience approximately 3.2+/−0.6 longer shelf life than the avocados 0 and 1. The techniques described herein are beneficial to quantify and identify such improvements in shelf life, which is attributed to the shelf life extension coating solution. Such techniques can therefore be beneficial to determine additional improvements/modifications that may be made to the shelf life extension coating solution.

Volume over time graph 1604 similarly shows that the avocados 2 and 3 have improved/longer shelf lives (e.g., duration, duration score) than the avocados 0 and 1, since the avocados 2 and 3 are treated by the shelf life extension coating solution and the avocados 0 and 1 are not. A threshold level 1606 is identified as the percent in volume shrink that signifies an end of shelf life (e.g., an end of duration, ripeness, edibility, salability). The threshold level 1606 in this example is 90% of the original volume of the avocado. As described throughout this disclosure, the threshold level can be different based on the produce, a type of produce, and/or one or more other characteristics associated with the produce (e.g., place of origin). An intersection of the change in volume over time for an avocado with the threshold level 1606 indicates an amount of time of shelf life for that particular avocado.

Accordingly, in the example of the graph 1604, avocado 0 intersects the threshold level 1606 at approximately 8-9 days (1608). Avocado 1 intersects the threshold level 1606 at approximately 9-10 days (1608). Avocado 2 intersects the threshold level 1606 at approximately 27 days (1610). Avocado 3 intersects the threshold level 1606 at approximately 25 days (1610).

The graphs 1602 and 1604 can be beneficial to visualize impacts on quality attributes of produce when produce is treated with the shelf life extension coating solution. Such output can be beneficial to verify positive impacts on quality of produce from application of the shelf life extension coating solution. Such output can also be beneficial to determine potential modifications that can be made to the shelf life extension coating solution in order to further improve the benefits it may have on quality of produce.

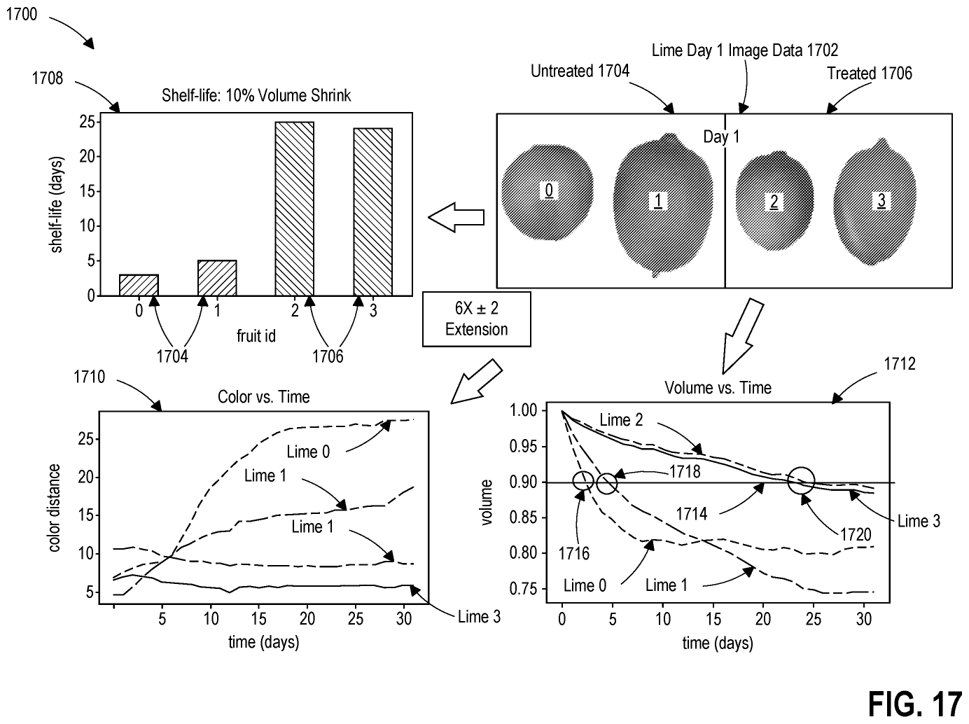

FIG. 17 is an example shelf life analysis 1700 of limes using the disclosed techniques. The shelf life analysis 1700 can be based on changes in color, changes in volume, or a combination of both. Image data 1702 of untreated limes 1704 and treated limes 1706 can be received by a computer system, such as the computer system 110. The computer system can identify and extract pixels representing each of the limes 1704 and 1706. The computer system can also apply a grid structure to the image data 1702 and determine indexes for each of the limes 1704 and 1706. Accordingly, a first lime can be indexed and labeled as lime 0. A second lime can be indexed and labeled as lime 1. Limes 0 and 1 are untreated limes 1704. A third lime can be indexed and labeled as lime 2. A fourth lime can be indexed and labeled as lime 3. Limes 2 and 3 are treated limes 1706. The computer system can implement one or more other indexing and labeling schemes. The indexes for each of the limes 1704 and 1706 can be used to identify changes in color and/or volume for each of the limes 1704 and 1706 over time.

Using the techniques described herein, the computer system can determine that the limes 2 and 3 (treated limes 1706) experience 6+/−2 times longer duration (e.g., shelf life, ripeness, edibility, salability) than the limes 0 and 1 (untreated limes 1704).

Three different types of outputs are visualized in FIG. 17. One or more other types of outputs can also be realized and determined using the techniques described herein in order to visually depict an impact of coating the treated limes 1706 in the shelf life extension coating solution.

Graph 1708 depicts shelf life of each of the limes 1704 and 1706 based on change in volume. 10% volume shrink is used as a threshold level for the limes 1704 and 1706. Thus, lime 0 (untreated lime 1704) experiences 10% of its original volume at approximately 3 days. The shelf life (e.g., duration) of lime 0 is therefore 3 days. Lime 1 (untreated lime 1704) experiences 10% volume shrink at approximately 6 days. The shelf life of lime 1 is therefore 6 days. Lime 2 (treated lime 1706) experiences 10% volume shrink at approximately 25 days and lime 3 (another treated lime 1706) experiences 10% volume shrink at approximately 23 days. Thus, the limes 2 and 3, both treated limes 1706, experience shelf lives that are on average over 6 times longer than shelf lives of the untreated limes 1704, limes 0 and 1. A standard deviation can be 2, in some implementations.

Graph 1710 depicts change in color of each of the limes 1704 and 1706. Lime 0 experiences the biggest and most sudden change in color compared to the other limes 1, 2, and 3. Limes 2 and 3 experience the least change in color, which can be attributed to being treated in the shelf life extension coating solution. In fact, as shown in the graph 1710, the limes 2 and 3 experience relatively constant color, thereby indicating that the limes 2 and 3, both treated limes 1706, experience longer duration (e.g., edibility, salability, shelf life, ripeness) than the limes 0 and 1, both untreated limes 1704.

Graph 1712 depicts shelf life of each of the limes 1704 and 1706 based on change in volume. As described in reference to the graph 1710, 10% volume shrink can indicate a threshold level 1714. An intersection of each of the limes 1704 and 1706 with the threshold level 1714 indicates a shelf life for each of the limes 1704 and 1706. Accordingly, lime 0 intersects with the threshold level 1714 at approximately day 3. Thus, the shelf life of the lime 0 is 3 days. Lime 1 intersects with the threshold level 1714 at approximately day 6. Lime 1 therefore has a shelf life of 6 days. Limes 2 and 3 intersect with the threshold level 1714 at approximately day 25. Therefore, limes 2 and 3, both treated limes 1706, have shelf lives of approximately 25 days.

As mentioned throughout, the graphs 1708, 1710, and 1712 are beneficial to visually depict the differences in quality attributes that are experienced by the untreated limes 1704 versus the treated limes 1706. A user can view the graphs 1708, 1710, and/or 1712 to quantify an improvement on duration that results from coating the treated limes 1706 in the shelf life extension coating solution. The user can use the graphs 1708, 1710, and/or 1712 to also determine whether and what type of modifications to make to the shelf life extension coating solution.

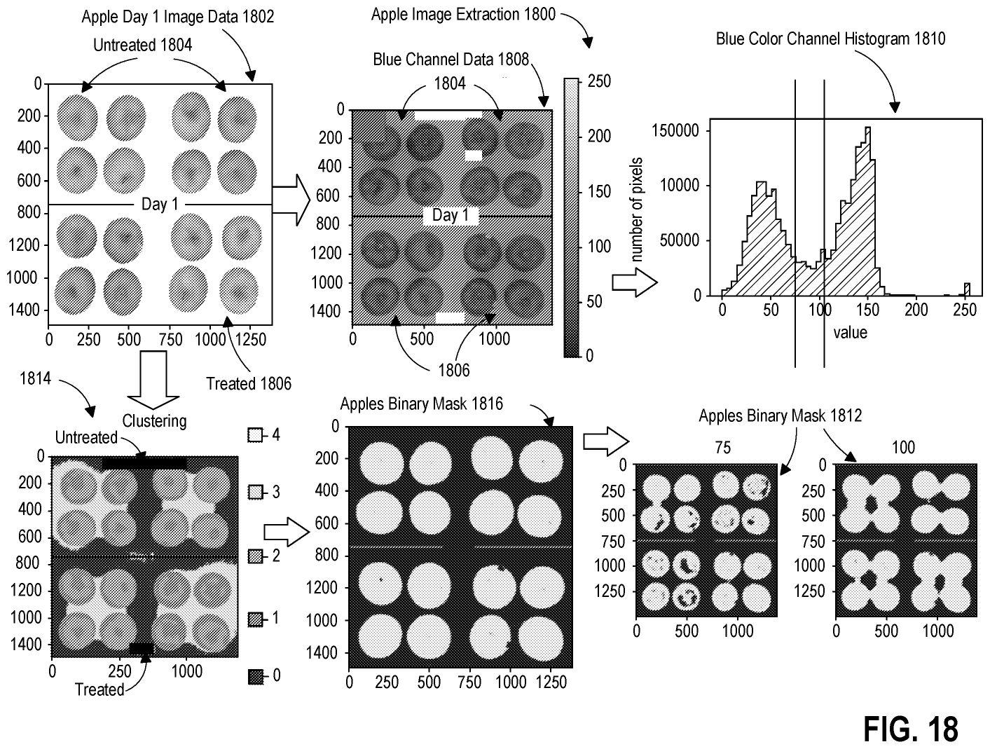

FIG. 18 depicts example techniques for extracting apples 1800 or other produce from image data. A computer system, such as the computer system 110, can receive image data 1802 of the apples on a first day of imaging. Untreated apples 1804 and treated apples 1806 can be captured in the image data 1802. In the example of FIG. 18, 16 apples are imaged, 8 untreated apples 1804 and 8 treated apples 1806. The same 16 apples are imaged each day for an entire period of time that the apples 1804 and 1806 are imaged.

The computer system can then identify and extract each of the apples 1804 and 1806 using one or more different techniques. For example, the computer system can identify and extract each of the apples 1804 and 1806 using blue color channel histogram 1810. The computer system can also identify and extract each of the apples 1804 and 1806 using clustering 1814.

In the blue color channel histogram 1810, the computer system can generate blue channel data 1808 from the image data 1802. The blue channel is represented by values between 0 and 255, which are shown in the blue channel data 1808 by colors between purple (0) and yellow (255). A mask can be used to extract the RGB data for the apples 1804 and 1806 by grabbing all RGB values of pixels from the image data 1802 for which the mask is True/1. For example, pixels in the blue channel data 1808 that have color values between 0 and 75 (which represent varying shades of purple) can be extracted for representing the apples 1804 and 1806. A significant quantity of pixels (e.g., as many as 100,000 pixels at one color value) in the blue channel data 1808 has values between 0 and 75, and therefore likely are representative of the apples 1804 and 1806. Another significant quantity of pixels (e.g., as many as 145,000 pixels at one color value) have color values between 100 and 175. This quantity of pixels can represent the background. Pixels having color values between 75 and 100 may be representative of either apples 1804 and 1806 or the background. Thus, during RGB pixel extraction, sometimes portions of the apples 1804 and 1806 may not be extracted from the blue channel data 1808. As a result, as shown by apples binary mask 1812, portions of the apples 1804 and 1806 may be missing. In some implementations, portions of the background can be present in the apples extracted data. Depending on the threshold used, some pixels of the apples 1804 and 1806 may be lost (e.g., when using 75 as a threshold) and/or some pixels of the unwanted background can appear in the extracted data (e.g., when using 100 as a threshold). The computer system may not be able to accurately quantify changes of color in the apples 1804 and 1806 if portions of the apples 1804 and 1806 are missing from the apples binary mask 1812 or if portions of the background are present.

Accordingly, the computer system can also identify and extract the apples 1804 and 1806 using clustering techniques 1814. Clustering 1814 can provide for more accurate extraction of the apples 1804 and 1806 such that fewer or no portions of the apples 1804 and 1806 are missing. As a result, the computer system can more accurately quantify color changes in the apples 1804 and 1806. Clustering the apples 1804 and 1806 can produce apples binary mask 1816. Complete apples 1804 and 1806 can be extracted using clustering techniques 1814, as shown in the apples binary mask 1816 in comparison to gaps and portions of the apples 1804 and 1806 that are missing in the apples binary mask 1812.

The computer system can identify color values from the image data 1802 that indicate the apples 1804 and 1806 as well as the background. The computer system can then cluster the identified color values. In other words, the computer system can graph all color channels in 3D space to then identify clusters of different colors. The computer system can identify which clusters are indicative of apples and which are indicative of the background by looking for clusters of colors in particular 3D spaces. Using discrimination techniques, the computer system can select which clusters to keep (e.g., clusters indicative of apples) and remove the unselected clusters (e.g., clusters indicative of the background).

In clustering 1814 the example apples 1804 and 1806 of FIG. 18, 4 different clusters of colors are identified. Cluster 0 represents a purple color channel. Cluster 1 represents a dark blue color channel. Cluster 2 represents a light blue color channel. Cluster 3 represents a green color channel. By the way the clusters 0, 1, 2, and 3 appear in 3D space, the computer system can determine that clusters 1 and 2 represent the apples 1804 and 1806 and clusters 0 and 3 represent the background. A clustering model can, for example generate a list of centers of clusters in the RGB space. This information can then be used by the computer system to determine which 2 clusters are in the background and thus discard all pixels in those 2 clusters. Accordingly, the computer system can select and extract the clusters 1 and 2. The apples binary mask 1816 therefore depicts cleaner and more defined shapes for the apples 1804 and 1806 in comparison to the apples binary mask 1812, which includes more gaps or missing portions from the apples 1804 and 1806.

Blue color channel histogram 1810 can be beneficial for one or more types of produce, such as avocados, limes, and lemons. Blue color channel histogram 1810 may not be preferred for other types of produce that may have more colors, such as apples and mangos. Clustering 1814 can be used for any type of produce that is imaged.

The techniques described herein can be used with hyperspectral images of the apples 1804 and 1806 to detect quality attributes such as firmness of the apples 1804 and 1806. Quality attributes such as firmness can be more effective indicators of duration of the apples 1804 and 1806 in comparison to color and/or volume for other types of produce, such as avocados, lemons, and limes. The computer system can use one or more machine learning models that are trained to predict firmness of the apples 1804 and 1806 based on the hyperspectral images. The models can be trained with training image data that is labeled by firmness measurements that are captured by penetrometers. The models can be trained to predict firmness of the apples 1804 and 1806 based on a combination of the penetrometer firmness measurements and the hyperspectral training image data. The firmness of the apples 1804 and 1806 can then be used by the computer system to determine the duration of the apples 1804 and 1806.

FIG. 19 is an example shelf life analysis 1900 of apples using the disclosed techniques. A computer system, such as the computer system 110, can receive image data 1802 of the apples 1804 and 1806. The computer system can also receive image data of the apples 1804 and 1806 at one or more different time intervals throughout a period of time that the apples 1804 and 1806 are imaged. The computer system can process the image data, such as the image data 1802, to determine quality attributes of the apples 1804 and 1806 over time. The computer system can determine quality attributes for each of the apples 1804 and 1806. Apples having indexes or identifiers of 0-7 are untreated apples 1804 and apples having indexes or identifiers of 8-15 are treated apples 1806. Based on how the quality attributes change over time, the computer system can determine duration for each of the apples 1804 and 1806. The computer system can, for example, determine the duration of the apples 1804 and 1806 based on changes in color, changes in volume, or a combination of both.

Graph 1902 depicts shelf life of the apples 1804 and 1806 based on change in color. A threshold change in color can be used to determine at what time point each of the apples 1804 and 1806 reach the end of their shelf lives. The threshold change in colors can be up to 13 color distance. In other words, the threshold change in colors can be a color distance of 13 from the original color of the apples 1804 and 1806 on a first day of imaging (e.g., the statistical measure color value, as described throughout this disclosure). As shown in the graph 1902, the untreated apples 1804 (apples 0-7) reach the threshold change in colors between 20 and 60 days from first imaging. The treated apples 1806 (apples 8-15) reach the threshold change in colors in more than 100 days from first imaging. As a result, a lower bound for duration of the treated apples can be set. Thus, by treating the apples 1806 in the shelf life extension coating solution, the apples 1806 experience at least 2.4 times longer duration (e.g., ripeness, edibility, shelf life, salability) than the untreated apples 1804.

Graph 1904 depicts shelf life of the apples 1804 and 1806 based on change in color over time. As mentioned above, the threshold change in color is a color distance of 13 from the original color of the apples 1804 and 1806 on a first day of imaging (e.g., the statistical measure color value). As shown in the graph 1904, the untreated apples 1804 reach the threshold change in color between 20 and 60 days from first imaging. The treated apples 1806, on the other hand, never cross the threshold change in colors over 100 days. As a result of treating the apples 1806 in the shelf life extension coating solution, the treated apples 1806 experience longer duration than the untreated apples 1804.

Graph 1906 depicts change in volume over time for the apples 1804 and 1806. Apples in general may not change as much in volume as other produce, such as avocados and mangos. Thus, change in volume over time may not be as effective of a quality attribute to use in measuring duration of apples. Regardless, on average, the graph 1906 demonstrates that the treated apples 1806 shrink in volume at a much slower rate than the untreated apples 1804. The treated apples 1806 shrink in volume at a constant rate and go from 1.0 of volume to 0.9 of volume over 100 days. The untreated apples 1804, on the other hand, shrink in volume at random, sporadic rates. The untreated apples 1804 shrink, on average, from 1.0 of volume to 0.8 or less of volume over 100 days. Thus, the graph 1906 demonstrates that the untreated apples 1804 more visibly shrink in volume over time in comparison to the treated apples 1906. The treated apples 1806 therefore have a longer duration (e.g., shelf life, edibility, salability, ripeness) than the untreated apples 1804.

FIG. 20 is a flowchart of a process 2000 for determining what quality metrics, machine learning models, and/or quality thresholds to select for a type of produce that is being imaged over time. The process 2000 can be performed as part of block 312 in the process 300 (e.g., refer to FIGS. 3A-B), when the computer system applies one or more machine learning models and/or algorithms for the extracted produce. The process 2000 can also be performed at before or after one or more other blocks in the process 300. For example, the process 2000 can be performed as part of performing object detection to identify bounding boxes for each produce in image data (block 304 in the process 300). The process 2000 can be performed once for all of the produce in the image data. For example, the process 2000 can be performed at a first time when the produce is imaged (e.g., day 1).

The process 2000 can be performed by the computer system 110. The process 2000 can also be performed by one or more other computers, computer systems, devices, cloud-based services, and/or network of computers and/or devices. For example, the process 2000 can be performed by an edge computing device. For illustrative purposes, the process 2000 is described from a perspective of a computer system.

Referring to the process 2000, the computer system can identify a produce type in the image data (2002). The computer system can apply one or more machine learning trained models to the image data that can be trained to identify the type of produce appearing in the image data. In some implementations, the computer system can receive metadata with the image data that includes some identifier that identifies the produce. In yet some implementations, a user can provide, as input to the computer system, information that identifies the produce.

The computer system can then select one or more duration scoring metrics from a plurality of metrics for the identified produce type in 2004. In other words, the computer system can retrieve from a data store one or more metrics that can be used for determining duration of the particular type of produce. For example, if the produce is identified as avocados in block 2002, the computer system can use the avocado identifier to select which quality metrics are used to determine duration of the produce. Thus, if duration of avocados is typically determined using color and volume changes of the avocados, then the computer system can select color and volume as the quality metrics that will be determined in block 314 of the process 300 in FIGS. 3A-B. As another example, if the produce is identified as apples in block 2002, the computer system can use the apple identifier to select, from a data store, particular quality metrics that are used to determine duration of apples. In some implementations, the selected quality metrics can be just color, just firmness, and/or a combination of one or more other quality attributes that are described throughout this disclosure.

In 2006, the computer system can select one or more thresholds for the selected one or more metrics for the identified produce type. The computer system can use the identifier indicating the produce type to determine what thresholds are used when determining duration (e.g., shelf life, edibility, salability, ripeness) of the produce. For example, if the produce is identified as avocados and the computer system selects color and volume as quality metrics, the computer system can then select the appropriate threshold levels for avocados based on color and volume. In other words, the computer system can identify a threshold level for shelf life of avocados based on color and a threshold level for shelf life of avocados based on volume. These threshold levels can be previously identified by a computer system and/or a relevant stakeholder. These threshold levels can be stored in a data store or other storage and accessed by the computer system at a later time. As described above, the threshold levels can be selected for all the produce in the image data when the produce is first imaged. The same selected threshold levels can then be used at subsequent time intervals throughout a period of time of imaging.

The computer system can also select one or more machine learning models and/or algorithms for the selected one or more metrics for the identified produce type (2008). The computer system can use the identifier indicating the produce type to determine what models and/or algorithms are used to determine duration of the produce. For example, if the produce is identified as mangos and the computer system selects a quality metric of wrinkles, the computer system can select, from a data store, one or more models and/or algorithms that are used to identify and quantify wrinkles of the mangos. The computer system can also select, from the data store, one or more models and/or algorithms that are used to determine duration of the mangos based on identifying and quantifying wrinkles over time.

The computer system can perform blocks 2004, 2006, and 2008 in any order. The computer system can perform blocks 2004, 2006, and 2008 in series. In some implementations, the computer system can simultaneously perform blocks 2004, 2006, and 2008 (e.g., in parallel).

The computer system then apply the one or more selected machine learning models and/or algorithms to the extracted produce in the image data in 2010. The computer system can apply the models and/or algorithms to the image data in order to determine the duration scoring metrics for the produce and also the duration of the produce. Thus, the computer system can return to block 314 in the process 300 to determine duration scoring metrics for the extracted produce.

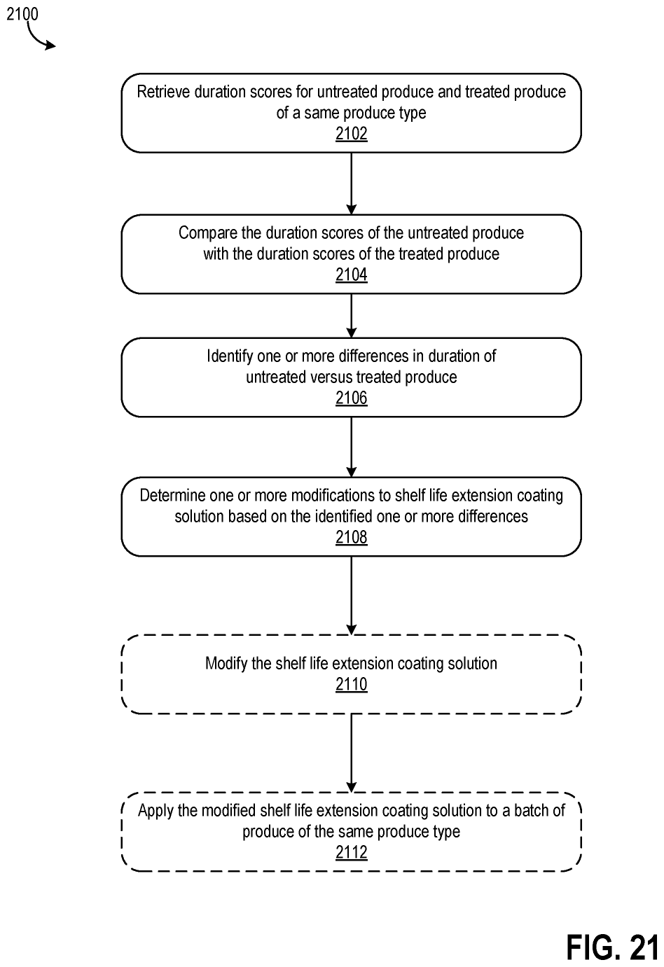

FIG. 21 is a flowchart of a process 2100 for comparing shelf life of treated versus untreated produce to determine one or more modifications to a shelf life extension coating solution. The process 2100 can be performed once the computer system determines duration scores for the produce, both treated and untreated produce, that are imaged over a period of time. The process 2100 can be performed autonomously and/or semi-autonomously by a computer system. In some implementations, one or more blocks in the process 2100 can be performed by a relevant stakeholder (e.g., user) in the supply chain.

The process 2100 can be performed by the computer system 110. The process 2100 can also be performed by one or more other computers, computer systems, devices, cloud-based services, and/or network of computers and/or devices. For example, the process 2100 can be performed by an edge computing device. For illustrative purposes, the process 2100 is described from a perspective of a computer system.

Referring to the process 2100, the computer system can retrieve duration scores for untreated produce and treated produce of a same produce type in 2102. The duration scores can be stored and accessible in one or more data stores, databases, and/or cloud-based storage services. The computer system can retrieve each duration score that was determined for each produce in image data using the process 300 in FIGS. 3A-B. In some implementations, the computer system can retrieve an average duration score for all treated produce in the image data and an average duration score for all untreated produce in the image data. In yet some implementations, the computer system can retrieve duration scores for treated and untreated produce of different batches of produce of the same type. For example, duration scores can be retrieved for treated and untreated avocados of a first batch that was imaged during a first period of time. Duration scores can also be retrieved for treated and untreated avocados of a second batch that was imaged during a second period of time.

The computer system can then compare the duration scores of the untreated produce with the duration scores of the treated produce of the same produce type (2104). The computer system can compare the duration scores by graphing the changes in quality attributes (e.g., duration scoring metrics) of the treated and untreated produce in one or more graphical depictions (e.g., line graphs, histograms, bar graphs, etc.). The computer system can also compare the duration scores for the treated and untreated produce based on finding a difference between the scores and/or determining how much each of the duration scores deviate from a threshold level/range.

The computer system can identify one or more differences in duration of the untreated versus the treated produce (2106). As mentioned above, the computer system can determine how much each of the duration scores deviate from a threshold level/range. The computer system can determine how much greater the duration scores of the treated produce are in comparison to the duration scores of the untreated produce. This difference in duration scores can indicate how much the treated produce's duration is extended by application of the shelf life extension coating solution. The difference in duration scores can also be used to determine whether the shelf life extension coating solution is effective enough and/or whether modifications can be made to the shelf life extension coating solution to further enhance the improvements of the solution on duration of the produce.

Accordingly, the computer system can determine one or more modifications to the shelf life extension coating solution based on the identified one or more differences (2108). For example, using one or more machine learning trained algorithms, the computer system can generate suggestions to modify the shelf life extension coating solution that may improve the duration of produce treated with such solution. In some implementations, a relevant stakeholder may determine one or more modifications to the shelf life extension coating solution, with or without the assistance of the computer system's models, algorithms, and/or techniques.

One or more different modifications can be determined. For example, modifications can include increasing or decreasing a concentration of a formula for the shelf life extension coating solution. The concentration of the formula can determine a thickness of the solution. For climacteric fruit like avocados, there can be an optimal concentration since climacteric fruit ripen by breathing (e.g., consuming oxygen and emitting CO₂). The solution extends shelf life by reducing the rate of this breathing process, but if this process is reduced too much, the fruit might not ripen and thus can go bad. Too low of a concentration may also not be desirable because that can result in a shelf life extension that is shorter than it could be. Each produce can also have a different formula and concentration based on characteristics of the produce as part of its development process.

Other example modifications can include adding wetting agents to the concentration of the formula. Different produce can have different surfaces, and depending on the kind of surface, the formula can spread nicely and evenly, wetting and covering the entire surface (optimal), or the formula can be concentrated in droplets on the surface, therefore creating a no uniform barrier that may reduce the shelf life extension performance. Adding a wetting agent can therefore help improve wetting and create a more uniform coating for the produce.

Another example modification can include modifying the shelf life extension coating solution application process. For example, a speed of a brush bed that is used for the application can be increased (e.g., to increase throughput) or decreased (e.g., to ensure better coating coverage). As another example, a temperature of a dryer can be increased to ensure that the coating dries fully on the produce or decreased to ensure that no damage is caused to the produce (which can depend on the produce characteristics, such as size of the produce, thickness of the produce's peel, etc.).

Optionally, the computer system can modify the shelf life extension coating solution in 2110. For example, the computer system can instruct one or more equipment or other computing systems to adjust concentration levels of one or more compounds or elements that comprise the shelf life extension coating solution. In some implementations, the computer system can transmit instructions, suggestions, and/or guidance to a user device that can be viewed by a relevant stakeholder in the supply chain. The relevant stakeholder can then determine whether to implement any of the instructions, suggestions, and/or guidance to modify the shelf life extension coating solution. The relevant stakeholder can manually implement the determined modifications. In some implementations, the relevant stakeholder can control one or more other computing systems and/or equipment to autonomously or semi-autonomously implement the determined modifications.

Optionally, the computer system may apply the modified shelf life extension coating solution to a batch of produce of the same produce type in 2112. Once the solution is modified, the computer system can, for example, transmit instructions to another computing system and/or equipment that cause the equipment to automatically coat subsequent batches of the produce in the modified solution. In some implementations, the computer system can transmit instructions to the user device of one or more relevant stakeholders to apply the modified solution to the produce. The relevant stakeholders can then manually apply the modified solution to subsequent batches of the produce and/or control equipment to apply the modified solution. In some implementations, the relevant stakeholders can also approve of the modifications to the solution, thereby causing one or more computing systems and/or equipment to semi-autonomously apply the modified solution to the produce.

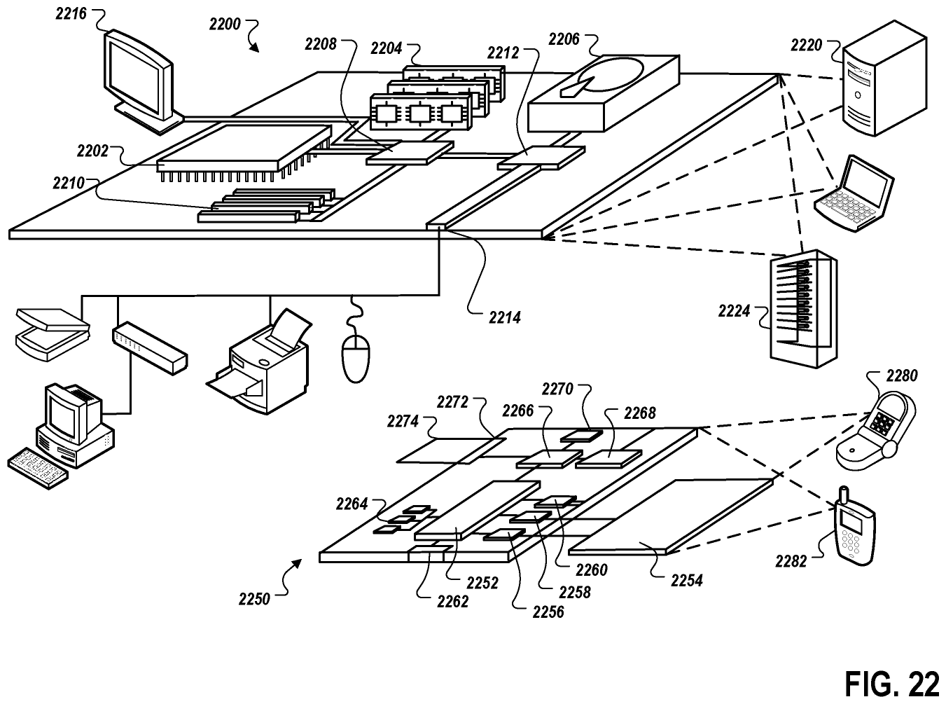

FIG. 22 is a block diagram of system components that can be used to implement a system for assessing the quality of one or more food items. The computing device 2200 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 2200 includes a processor 2202, a memory 2204, a storage device 2206, a high-speed interface 2208 connecting to the memory 2204 and multiple high-speed expansion ports 2210, and a low-speed interface 2212 connecting to a low-speed expansion port 2214 and the storage device 2206. Each of the processor 2202, the memory 2204, the storage device 2206, the high-speed interface 2208, the high-speed expansion ports 2210, and the low-speed interface 2212, are interconnected using various busses, and can be mounted on a common motherboard or in other manners as appropriate. The processor 2202 can process instructions for execution within the computing device 2200, including instructions stored in the memory 2204 or on the storage device 2206 to display graphical information for a GUI on an external input/output device, such as a display 2216 coupled to the high-speed interface 2208. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 2204 stores information within the computing device 2200. In some implementations, the memory 2204 is a volatile memory unit or units. In some implementations, the memory 2204 is a non-volatile memory unit or units. The memory 2204 can also be another form of computer-readable medium, such as a magnetic or optical disk.

The storage device 2206 is capable of providing mass storage for the computing device 2200. In some implementations, the storage device 2206 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 2204, the storage device 2206, or memory on the processor 2202.

The high-speed interface 2208 manages bandwidth-intensive operations for the computing device 2200, while the low-speed interface 2212 manages lower bandwidth-intensive operations. Such allocation of functions is exemplary only. In some implementations, the high-speed interface 2208 is coupled to the memory 2204, the display 2216 (e.g., through a graphics processor or accelerator), and to the high-speed expansion ports 2210, which can accept various expansion cards (not shown). In the implementation, the low-speed interface 2212 is coupled to the storage device 2206 and the low-speed expansion port 2214. The low-speed expansion port 2214, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 2200 can be implemented in a number of different forms, as shown in the figure. For example, it can be implemented as a standard server 2220, or multiple times in a group of such servers. In addition, it can be implemented in a personal computer such as a laptop computer 2222. It can also be implemented as part of a rack server system 2224. Alternatively, components from the computing device 2200 can be combined with other components in a mobile device (not shown), such as a mobile computing device 2250. Each of such devices can contain one or more of the computing device 2200 and the mobile computing device 2250, and an entire system can be made up of multiple computing devices communicating with each other.

The mobile computing device 2250 includes a processor 2252, a memory 2264, an input/output device such as a display 2254, a communication interface 2266, and a transceiver 2268, among other components. The mobile computing device 2250 can also be provided with a storage device, such as a micro-drive or other device, to provide additional storage. Each of the processor 2252, the memory 2264, the display 2254, the communication interface 2266, and the transceiver 2268, are interconnected using various buses, and several of the components can be mounted on a common motherboard or in other manners as appropriate.

The processor 2252 can execute instructions within the mobile computing device 2250, including instructions stored in the memory 2264. The processor 2252 can be implemented as a chipset of chips that include separate and multiple analog and digital processors. The processor 2252 can provide, for example, for coordination of the other components of the mobile computing device 2250, such as control of user interfaces, applications run by the mobile computing device 2250, and wireless communication by the mobile computing device 2250.

The processor 2252 can communicate with a user through a control interface 2258 and a display interface 2256 coupled to the display 2254. The display 2254 can be, for example, a TFT (Thin-Film-Transistor Liquid Crystal Display) display or an OLED (Organic Light Emitting Diode) display, or other appropriate display technology. The display interface 2256 can comprise appropriate circuitry for driving the display 2254 to present graphical and other information to a user. The control interface 2258 can receive commands from a user and convert them for submission to the processor 2252. In addition, an external interface 2262 can provide communication with the processor 2252, so as to enable near area communication of the mobile computing device 2250 with other devices. The external interface 2262 can provide, for example, for wired communication in some implementations, or for wireless communication in other implementations, and multiple interfaces can also be used.

The memory 2264 stores information within the mobile computing device 2250. The memory 2264 can be implemented as one or more of a computer-readable medium or media, a volatile memory unit or units, or a non-volatile memory unit or units. An expansion memory 22224 can also be provided and connected to the mobile computing device 2250 through an expansion interface 22222, which can include, for example, a SIMM (Single In Line Memory Module) card interface. The expansion memory 22224 can provide extra storage space for the mobile computing device 2250, or can also store applications or other information for the mobile computing device 2250. Specifically, the expansion memory 22224 can include instructions to carry out or supplement the processes described above, and can include secure information also. Thus, for example, the expansion memory 22224 can be provide as a security module for the mobile computing device 2250, and can be programmed with instructions that permit secure use of the mobile computing device 2250. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 2264, the expansion memory 22224, or memory on the processor 2252. In some implementations, the computer program product can be received in a propagated signal, for example, over the transceiver 2268 or the external interface 2262.

The mobile computing device 2250 can communicate wirelessly through the communication interface 2266, which can include digital signal processing circuitry where necessary. The communication interface 2266 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 2268 using a radio-frequency. In addition, short-range communication can occur, such as using a Bluetooth, WiFi, or other such transceiver (not shown). In addition, a GPS (Global Positioning System) receiver module 22220 can provide additional navigation- and location-related wireless data to the mobile computing device 2250, which can be used as appropriate by applications running on the mobile computing device 2250.

The mobile computing device 2250 can also communicate audibly using an audio codec 2260, which can receive spoken information from a user and convert it to usable digital information. The audio codec 2260 can likewise generate audible sound for a user, such as through a speaker, e.g., in a handset of the mobile computing device 2250. Such sound can include sound from voice telephone calls, can include recorded sound (e.g., voice messages, music files, etc.) and can also include sound generated by applications operating on the mobile computing device 2250.

The mobile computing device 2250 can be implemented in a number of different forms, as shown in the figure. For example, it can be implemented as a cellular telephone 2280. It can also be implemented as part of a smart-phone 2282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for determining duration of produce using image data, the method comprising:
receiving, by a computing system and from an imaging device, image data of produce that is captured at consistent time intervals during a period of time, wherein the image data includes one or more treated produce that is coated in a shelf life extension coating solution and one or more untreated produce that is not coated in the shelf life extension coating solution during the period of time, wherein the treated produce and the untreated produce are a same produce type;
performing, by the computing system, object detection techniques on the image data to identify a bounding box around each produce in the image data;
identifying, by the computing system, quality attributes for each of the produce in each bounding box at each of the time intervals during the period of time, wherein the quality attributes include at least one of color, volume, firmness, wrinkles, rot, or mold;
determining, by the computing system and for each of the produce in the image data, one or more duration scoring metrics based on comparing the identified quality attributes for the produce over the period of time; and
transmitting, by the computing system, the one or more duration scoring metrics for each of the produce to a user device for display in a graphical user interface (GUI).

2. The method of claim 1, further comprising storing, by the computing system in a data store and for each of the produce, (i) the bounding box, (ii) the quality attributes, and (iii) the duration scoring metrics.

3. The method of claim 1, further comprising:
determining, by the computing system, a grid structure for the image data; and
assigning, by the computing system, a grid index in the grid structure to each bounding box, wherein the grid index is used to identify the produce in the bounding box.

4. The method of claim 1, further comprising determining, by the computing system, a duration score for the produce in the image data based on determining an extension of shelf life duration from the one or more duration scoring metrics, wherein the extension of shelf life duration is experienced by the treated produce in comparison to the untreated produce over the period of time.

5. The method of claim 4, further comprising determining, by the computing system and based at least in part on the one or more duration scoring metrics and the duration score for the produce, one or more modifications to make to the shelf life extension coating solution.

6. The method of claim 5, further comprising transmitting, by the computing system, instructions to a controller of supply chain actors to modify the shelf life extension coating solution based on the determined one or more modifications.

7. The method of claim 5, wherein the one or more modifications include instructions that, when executed by supply chain actors, cause at least one of (i) increasing a concentration of one or more components of the shelf life extension coating solution, (ii) decreasing a concentration of one or more components of the shelf life extension coating solution, (iii) applying the shelf life extension coating solution to a batch of untreated produce of the same produce type, (iv) increasing an amount of the shelf life extension coating solution to apply to subsequent batches of untreated produce of the same produce type, and (v) decreasing an amount of the shelf life extension coating solution to apply to subsequent batches of untreated produce of the same produce type.

8. The method of claim 1, further comprising:
mapping, by the computing system, RGB values from the image data into three dimensional (3D) space;
identifying, by the computing system, clusters of RGB values in the 3D space;
selecting, by the computing system, one or more of the clusters in the 3D space having a threshold center color; and
extracting, by the computing system, the selected one or more clusters from the image data, wherein the selected one or more clusters are representative of the treated produce and the untreated produce in the image data.

9. The method of claim 1, wherein:
identifying, by the computing system, quality attributes for each of the produce in each bounding box comprises identifying color values for all pixels in the bounding box, and
determining, by the computing system and for each produce in the image data, one or more duration scoring metrics comprises:
determining a distance between each of the identified color values and a statistical measure color value of the produce in the image data, wherein the statistical measure color value represents an average color of the treated produce and the untreated produce when the produce is imaged by the imaging device at a first time interval during the period of time;
determining whether a distance between each of the identified color values at each of the time intervals and the statistical measure color value exceeds a threshold level;
identifying a duration scoring metric for each produce as a time interval during the period of time when the distance between each of the identified color values and the statistical measure color value exceeds the threshold level; and
generating output that visually depicts the distance between each of the identified color values and the statistical measure color value for the produce at each time interval during the period of time.

10. The method of claim 9, wherein the statistical measure color value is determined, by the computing system, based on:
receiving, from the imaging device, image data of the produce at a first time interval during the period of time;
identifying color values for all pixels representing the produce in the image data at the first time interval; and
computing the statistical measure color value for the produce in the image data based on averaging the identified color values.

11. The method of claim 1, wherein the one or more duration scoring metrics correspond to, for each of the produce in the image data, at least one of ripeness, end of ripeness, length of ripeness, shelf life, end of shelf life, length of shelf life, edibility, end of edibility, length of edibility, salability, end of salability, and length of salability of the produce.

12. The method of claim 1, wherein identifying, by the computing system, quality attributes for each of the produce in each bounding box comprises:
determining an area of the produce in the bounding box based on counting a number of pixels representing the produce in the bounding box;
determining a radius of the produce based on the area and a circle area formula; and
determining a volume of the produce at each time interval based on the radius and a spherical volume formula,
wherein determining, by the computing system and for each of the produce in the image data, one or more duration scoring metrics further comprises:
determining a change in the volume of the produce at each time interval to a volume of the produce at a first time interval;
determining whether the change in volume exceeds a threshold level;
identifying a duration scoring metric for each produce as a time interval during the period of time when the change in volume exceeds the threshold level; and
generating output that visually depicts the change in volume for each produce at each time interval during the period of time.

13. The method of claim 12, wherein the threshold level is a 10% volume shrink between the volume of the produce at one of the time intervals and the volume of the produce at the first time interval.

14. The method of claim 1, wherein identifying, by the computing system, quality attributes for each of the produce in each bounding box comprises:
determining a grid structure for the produce in the bounding box;
retrieving, from a data store, a machine learning-trained wrinkle model that was trained using a set of training image data of other produce of the same type, the set of training image data being annotated based on previous identifications of a first portion of the other produce as having wrinkles and a second portion of the other produce as having no wrinkles; and
applying the wrinkle model to each grid cell in the grid structure to identify one or more patches of wrinkles,
wherein determining, by the computing system and for each of the produce in the image data, one or more duration scoring metrics comprises:
counting a fraction of grid cells having the patches of wrinkles for the bounding box;
determining whether the fraction of grid cells having the patches of wrinkles exceeds a threshold level;
identifying a duration scoring metric for the produce as a percent coverage in wrinkles based on a determination that the fraction of grid cells having the patches of wrinkles exceeds the threshold level; and
generating output that visually depicts the percent coverage in wrinkles for the produce.

15. The method of claim 1, wherein identifying, by the computing system, quality attributes for each of the produce in each bounding box comprises:
determining a grid structure for the for the produce in the bounding box;
retrieving, from a data store, a machine learning-trained quality features model that was trained using a set of training image data of other produce of the same type, the set of training image data being annotated based on previous identifications of a first portion of the other produce as having one or more of the quality features and a second portion of the other produce as having no quality features; and
applying the quality features model to each grid cell in the grid structure to identify one or more quality features, wherein the quality features include at least one of firmness, internal bruising, external bruising, internal infection, external infection, internal rot, external rot, dry matter content, pH, or sugar content,
wherein determining, by the computing system and for each of the produce in the image data, one or more duration scoring metrics comprises:
counting a fraction of grid cells having the quality features for the bounding box;
determining whether the fraction of grid cells having the quality features exceeds a threshold level;
identifying a duration scoring metric for the produce as a percent coverage in quality features based on a determination that the fraction of grid cells having the quality features exceeds the threshold level; and
generating output that visually depicts the percent coverage in quality features for the produce.

16. The method of claim 1, wherein the produce in the image data are avocados, (i) the quality attributes are at least one of color, volume, firmness, and ripeness, and (ii) the one or more duration scoring metrics are at least one of a change in color over the period of time, a change in volume over the period of time, a change in firmness over the period of time, and a change in ripeness over the period of time.

17. The method of claim 1, wherein the produce in the image data are limes or apples, the quality attributes are at least one of color, volume, and firmness, and the one or more duration scoring metrics are at least one of a change in color over the period of time, a change in volume over the period of time, and a change in firmness over the period of time.

18. The method of claim 1, further comprising:
identifying, by the computing system, produce type of the produce in the image data at a first time interval during the period of time;
selecting, by the computing system, one or more types of duration scoring metrics from a plurality of duration scoring metrics for the identified produce type;
selecting, by the computing system, one or more threshold levels for the selected types of duration scoring metrics for the identified produce type;
identifying, by the computing system, the quality attributes that correspond to each of the selected types of duration scoring metrics; and
determining, by the computing system, the selected one or more duration scoring metrics based on comparing the identified quality attributes with the selected one or more threshold levels.

19. The method of claim 1, further comprising:
retrieving, by the computing system and from a data store, duration scoring metrics of the treated produce and the untreated produce over the period of time;
identifying, by the computing system, one or more differences between the duration scoring metrics of the treated produce and the duration scoring metrics of the untreated produce; and
generating, by the computing system, output indicating the identified one or more differences, wherein the output includes one or more modifications to the shelf life extension coating solution, the one or more modifications being determined, by the computing system, based on the identified one or more differences.

20. A system for determining duration of produce using image data, the system comprising:
a conveyor system configured to route produce along a pathway through a facility;
one or more imaging devices positioned proximate the conveyor system and configured to capture image data of the produce at consistent time intervals during a period of time, wherein the produce is a same produce type; and
at least one computing system in communication with the one or more imaging devices, the at least one computing system configured to:
receive, from the one or more imaging devices, image data of the produce that is captured at the consistent time intervals during the period of time, wherein the image data includes one or more treated produce that is coated in a shelf life extension coating solution and one or more untreated produce that is not coated in the shelf life extension coating solution during the period of time, wherein the treated produce and the untreated produce are the same produce type;
perform object detection techniques on the image data to identify a bounding box around each produce in the image data;
identify quality attributes for each of the produce in each bounding box at each of the time intervals during the period of time, wherein the quality attributes include at least one of color, volume, firmness, wrinkles, rot, and mold;
determine, for each of the produce in the image data, one or more duration scoring metrics based on comparing the identified quality attributes for the produce over the period of time; and
transmit the one or more duration scoring metrics for each of the produce to a user device for display in a graphical user interface (GUI).
